(19) United States
(12) Patent Application Publication
(10) Pub. No.: US 2026/0196115 A1
(43) Pub. Date: Jul. 9, 2026

(54) INTRUSION DETECTION SYSTEM AND METHOD

(71) Applicant: Essence Security International (E.S.I.) Ltd., Herzlia Pituach (IL)

(72) Inventors: Ohad AMIR, Herzlia (IL); Jonathan Mark SCHNAPP, Tel Aviv (IL)

(21) Appl. No.: 19/441,740

(22) Filed: Jan. 6, 2026

(30) Foreign Application Priority Data
Jan. 6, 2025 (GB) 2500110.8

(51) Int. Cl. G08B 13/184

(52) U.S. Cl. CPC G08B 13/184

(57) ABSTRACT

A region is monitored to detect an intrusion. In some embodiments, the region has a boundary includes an acceptable boundary crossing that constitutes some of the boundary wherein the region is enterable via the acceptable boundary crossing. A first set of Ranging Active Reflective Wave Detector (RARWD) measurements from a RARWD configured to observe the region is received. From the first set of RARWD measurements, an acceptable entry detection region is determined. From a second set of RARWD measurements a current location of first appearance of an object entering the region is identified. It may be determined whether an object has entered the region via an anomalous entry location based on a position of the current location of first appearance with respect to the acceptable entry detection region. An output to signal an occurrence of an anomalous entry event is controlled.

### CROSS-REFERENCE TO RELATED APPLICATIONS

The present application claims priority to United Kingdom Application No. 2500110.8 filed with the Intellectual Property Office of the United Kingdom on Jan. 6, 2025, which is incorporated herein by reference in its entirety for all purposes.

### TECHNICAL FIELD

The present invention relates generally to a method, computer-readable storage medium and device and system for monitoring a region to detect an intruder.

### BACKGROUND

Intrusion detection systems are configured to identify intruders at premises. Such systems employ various different techniques to identify intruders and to discriminate between intruders and legitimate occupants.

Many systems are configured such that legitimate occupants that enter a vacant premises trigger the system into a state that will cause an alarm unless the legitimate occupant performs a disarming action within an entry delay period. The state is commonly entered by the system detecting a presence or movement of a person at the premises. The disarming action could involve, for example, entering a pin number into a keypad or disarming the system on a mobile phone associated with authorised users and/or providing a password and username, or the like.

Different systems may be configured to perform different actions in response to identifying a trigger condition for which a disarming action is not performed within the entry delay period. For example, some systems may directly raise an audible alarm, deploy deterrent measures, and/or notify a nominated recipient, such as a user or monitoring station, and/or the like.

In intrusion detection systems, false intruder detections are undesirable and may lead to undesirable outcomes such as false alarms, a waste of system resources in checking intrusion detections, unwanted power drain and the like. Furthermore, reducing the manual burden on users is preferable. As such, improved accuracy in the detection of intruders and/or discrimination between intruders and legitimate occupants can be of significant importance.

### SUMMARY

Various aspects of the present invention are defined in the independent claims. Some preferred features are defined in the dependent claims.

According to a first aspect of the present disclosure is a system for monitoring a region to detect an intrusion into a region. The region has a boundary wherein one or more acceptable boundary crossings constitute some of the boundary. The region is enterable via said one or more acceptable boundary crossings of the boundary. The system comprises at least one processor, wherein the system, e.g. the processor, is configured to receive a first set of Ranging Active Reflective Wave Detector (RARWD) measurements from a RARWD configured to observe the region. The system is configured to, from the first set of RARWD measurements, identify at least one acceptable entry detection region that defines where an object entering the region via an acceptable boundary crossing is expected to be first detectable upon entering the region. The at least one acceptable entry detection region may define where an object is expected to be first detectable from RARWD measurements upon entering the region via an acceptable boundary crossing. The system is configured to receive a second set of RARWD measurements to monitor for an intrusion into the region. The system is configured to identify from the second set of RARWD measurements a current location of first appearance of an object entering region, the current location comprising a position in space. The system is configured to determine whether an object has entered the region via an anomalous entry location based on a position of the current location of first appearance with respect to the at least one acceptable entry detection region. The system is configured to, responsive to determining that an object has entered the region via an anomalous entry location, control an output to signal an occurrence of an anomalous entry event.

In embodiments described herein, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), a location of first appearance of an object entering the region, and defining where a human is expected to be first detectable from RARWD measurements upon entering the region via an acceptable boundary crossing may more generally be defining where an object entering the region via an acceptable boundary crossing is expected to be first detectable upon entering the region. The location of first appearance of an object entering the region may comprise a location of an event indicative of first appearance of a human entering the region, e.g. a door opening, an object being thrown through a window or the like.

The second set of RARWD measurements may relate to a later time period than the first set of RARWD measurements. The second set of RARWD measurements may be collected after the first set of RARWD measurements. The second set of RARWD measurements may be received by the system after receiving the first set of RARWD measurements.

The identifying of the at least one acceptable entry detection region that defines where a human is expected to be first detectable from RARWD measurements upon entering the region via an acceptable boundary crossing may comprise learning at least one reference location of first appearance of a human in the first set of RARWD measurements for an entry into the region. Each of the at least one reference locations may comprise a position in space. The at least one acceptable entry detection region may comprise or be otherwise defined with respect to the at least one reference location of first appearance.

The system may comprise at least one RARWD configured to collect at least one or both of: the first set of RARWD measurements and/or the second set of RARWD measurements.

The region (i.e. the region monitored by the RARWD) may comprise an entirety or a part of an interior of a building. The interior may be, for example, a home or a business premises. The interior may be closable by one or more doors. The interior may correspond to an interior of the home or business premises. The region may comprise one or more rooms of the building. In examples, the region may comprise an outdoors region. The outdoors region may be defined by one or more virtual fences, and/or a range of the RARWD.

The region monitored by the RARWD may comprise an interior space within a physical structure, the physical structure being closable by having one or more physical barriers not intended to be passed through by a human; and may additionally comprise one or more external regions to the physical structure that are at least sometimes visible to the RARWD, e.g. sometimes visible if an opening such as a door, shutter or window is opened. In some embodiments the region monitored by the RARWD may be limited to a region with a software-defined virtual fence, e.g. to ensure the monitored region is confined to within the interior space, if so desired.

The system may be configured to identify the at least one acceptable entry detection region based on one or more entries to the region that change an occupancy of the monitored region from unoccupied to occupied. Optionally, the system may be configured to, when identifying the at least one acceptable entry detection region, exclude entries to the monitored region whilst the monitored region is already occupied or for which an immediately prior occupancy status of the monitored region is unknown.

The boundary may also include at least one unacceptable boundary crossing, wherein the region is also enterable by a human via said at least one unacceptable boundary crossing. In some embodiments, a human can enter the region via the at least one unacceptable boundary crossing to be first detected at a location outside said at least one acceptable entry detection region. The system may be configured to identify at least one unacceptable entry detection region. The at least one unacceptable entry detection region may define where a human is expected to be first detectable from RARWD measurements upon entering the region via the at least one unacceptable boundary crossing. The determining of whether a person has entered the region via an anomalous entry location may be based, at least in part, on a position of the current location of first appearance with respect to the at least one unacceptable entry detection region. The determining of whether a person has entered the region via an anomalous entry location may comprise determining whether the current location is within any of the at least one unacceptable entry detection regions. In response to the determining that the current location is within any of the at least one unacceptable entry detection regions the method may comprise determining that a person has entered the region via an anomalous entry location.

Optionally, in such an embodiment, the system may be configured to identify the at least one acceptable entry detection region so as to be agnostic to a prior occupancy status of the interior. This identifying the at least one acceptable entry detection region may include entries to the interior whilst the interior is already occupied or for which an immediately prior occupancy status of the monitored region is unknown.

At least part or all of the boundary is provided by a feature of the environment, such as a physical feature of the environment, e.g. a wall of a building. Likewise, the acceptable boundary crossings also be provided by a feature of the environment that acts as an access point or opening, such as a doorway or passageway.

At least one acceptable boundary crossing may correspond to a doorway. At least one acceptable boundary crossing may correspond to a gateway or other entrance. At least one acceptable boundary crossing may correspond to an opening into the region from another region. At least part of the boundary, other than the at least one acceptable boundary crossing, may correspond to a wall or other physical barrier. That is, at least part of the region being monitored, other than the at least one acceptable boundary crossing, may be bounded by a wall of other physical barrier through which the waves emitted by the RARWD can't pass. The opening may comprise a passageway, a corridor, an opening in a wall, or the like. At least one unacceptable boundary crossing may be provided by a feature of the environment that can act as an access point to the region, but for which access to the region is not intended. For example, the at least one unacceptable boundary crossing may correspond to a window.

The boundary may include edges of an RARWD field of view, which may include one or more acceptable boundary crossings of the boundary. Optionally all of the edges of the RARWD field of view, or at least all of the lateral edges of the RARWD, may be acceptable boundary crossings. This may be the case, for example, in embodiments where any occupancy status of the monitored region is unknown.

The position in space may be a position of a point, for example a center within the human. The center may, for example, be or be based on a weighted center of the measurement points associated with the human.

The first set of RARWD measurements and/or the second set of RARWD measurements may comprise one or more measurement frames, e.g. a plurality of measurement frames, each measurement frame of the plurality of measurement frames being for a different time or time period. A location of first appearance of a human in RARWD measurements for an entry into the region may comprise a location in an earliest measurement frame in which the human is detectable for a given instance of the human entering the region.

A location of first appearance of a human in RARWD measurements for an entry into the region may comprise a location based on an earliest set of measurement frames in which the human is detectable for a given instance of the human entering the region. The earliest set may comprise a predetermined number of successive measurement frames or a number of measurement frames recorded during predetermined maximum period of time (e.g. 1 second).

With each “location”, as used herein, comprising as a position in space, a spatial relationship (e.g. a distance) between different locations is determinable.

The system may be configured such that, after a person is first detected in the region from the second RARWD measurements, the system is configured to receive further RARWD measurements and from the further RARWD measurements track a position of the person. The system may be configured such that, conditional upon having determined that the person has not entered the region via an anomalous entry location, the person can, while being tracked, travel to the anomalous entry location without causing the output to signal an occurrence of an anomalous entry event. In other words, the system may be configured such that, conditional upon determining that the person has not entered the region via an anomalous entry location, said tracking of the position of the person does not, in response to the tracked position thereafter indicating that the person has travelled to the anomalous entry location, cause the output to signal an occurrence of an anomalous entry.

The at least one reference location of first appearance of a human in RARWD measurements for an entry into the region may comprise a plurality of reference locations of first appearance of a human in RARWD measurements for a respective plurality of entries into the region. In some embodiments, the human need not be the same human.

The system may be configured such that the determining of whether a person has entered the region via an anomalous entry location may comprise determining whether the current location fails to have a requisite spatial proximity relationship with respect to the at least one reference location of first appearance.

The RARWD may be configured such that the region observed by the RARWD may be an entire region from which the RARWD is configured to detect reflected waves. In other embodiments the region observed by the RARWD may be a region within a virtual fence. The virtual fence may be a defined sub-region of an entire region from which the RARWD is configured to detect reflected waves. This may be especially useful in outdoor applications, or other installations where one or more boundary crossings of a boundary of the region, or all of the boundary, may be unbound by physical barriers. Optionally the region may be bound by one or more physical structures, e.g. walls, windows, doors, etc., and/or one or more boundaries of what the RARWD can or could detect without physically obstructing structures.

The position in space of the reference location may be defined with respect to multiple, optionally three, orthogonal coordinates. The coordinates may for example be cartesian, polar or spherical coordinates. In the case of polar or spherical coordinates, a radial coordinate may be represented as a distance coordinate or it may map to a distance (e.g. a time of flight, etc.).

The system may be, or comprise, or be configured to, operate an alarm system. In some embodiments, the system, or the alarm system, is operable as outlined herein while not in an armed state (e.g. armed/set, part-armed/part-set, unarmed/unset). For example, the system may always be active, so a user need not arm/set the system when they leave the premises nor disarm/unset the system when they return to the premises. Optionally the system, or the alarm system, may operate without arming states. The first set of RARWD data may optionally comprise a plurality of subsets of frames of RARWD data, each subset corresponding to a different period of time. Optionally each of the at least one reference locations may be determined from respective ones of the plurality of the subsets.

Each acceptable entry detection region may comprise at least one reference location of first appearance of a human. Having the requisite proximity relationship may comprise that the current location of first appearance is within an acceptable entry detection region. Each acceptable entry detection region may comprise at least a predefined number of the reference locations of first appearance.

Additionally, or alternatively, having the requisite proximity relationship may comprise that the current location of first appearance is part of a spatial cluster of locations, the spatial cluster including at least a predefined number of the reference locations of first appearances.

In either case, in some embodiments, the predefined number is one. Thus, even if, from the first set of reference data, a person only appears once at a certain reference location, that reference location may be sufficient to define an acceptable entry detection region.

In other embodiments the predefined number may be two or more. Thus, an acceptable entry detection region may in this case more empirically represent an observed pattern or an observed habit of entering the region.

The system may be configured to calculate the predefined number. Optionally the predefined number may be dependent on a total number of the at least one reference locations. Thus, the predefined number may, for example, be calculated to represent a minimum required likelihood for a person's first appearance in the region to be in a given detection region in order to define that given detection region as an acceptable entry detection region.

The system may be configured to determine that an acceptable entrance-behavior condition is satisfied when the current location of first appearance corresponds to at least one acceptable entry detection region. In some embodiments, the system may be configured such that, in response to the current location of first appearance not corresponding to any of the at least one reference location of first appearance, an acceptable entrance-behavior condition is determined not to be satisfied.

The system may be configured to control the output by generating the output when the acceptable entrance-behavior condition is determined to be satisfied and/or when an acceptable entrance-behavior condition is determined not to be satisfied. For example, the non-provision of an output, e.g. in response to the receipt of the second set of RARWD measurements, may be indicative of occurrence of an anomalous entry event in examples that comprise generating the output when the acceptable entrance-behavior condition is determined to be satisfied, particularly in embodiments in which another device awaits the output to determine by, receiving the output, that an anomalous entry event has not occurred. In other examples, provision of an output, e.g. in response to the receipt of the second set of RARWD measurements, may be indicative of occurrence of an anomalous entry event in examples that comprise generating the output when the acceptable entrance-behavior condition is determined not to be satisfied. In examples, the output may contain data or a signal indicative of whether the acceptable entrance-behavior condition is determined to be satisfied or not satisfied.

Controlling the output to signal the occurrence of an anomalous entry event may comprise generating an alarm. The alarm may comprise an audible and/or visual signal. Controlling the output to signal the occurrence of an anomalous entry event may comprise requesting performance of a verification action, e.g. using at least one verification device such as a camera, a motion sensor, an audio sensor, a door or window opening sensor, a presence sensor, and/or the like. The system may be configured to generate an alarm subject to both the determination that a person has entered the region via an anomalous entry location and the verification action providing a confirmation result.

Controlling the output to signal the occurrence of an anomalous entry event may additionally or alternatively comprise the system indicating to another device, optionally wirelessly, that anomalous entry event has occurred. The indicating that anomalous entry event has occurred may comprise the system transmitting a message to indicate an occurrence of an anomalous event. Alternatively, the method may comprise the system transmitting an entry detected message upon detecting an entry and, conditional upon the person being determined to have entered the region not via an anomalous entry location, transmitting a non-anomalous entry message, wherein the indicating that an anomalous entry event has occurred comprises not transmitting the non-anomalous entry message.

As noted above, the determining by the system of the at least one acceptable entry detection region may comprise learning at least one reference location of first appearance of a human in the first set of RARWD measurements for an entry into the region.

The learning of the at least one reference location of first appearance of a human may comprise identifying all locations of first appearances of a human during a training period. The training period may be predetermined, but in other embodiments may be dynamically determined, e.g. it may last until some requirement is met, e.g. until a minimum number of first reference locations has been identified. The learning may employ any suitable learning algorithm as would be known by the person skilled in the art.

Learning the at least one reference location of first appearance of a human may comprise detecting a new object in the region based on the first set of RARWD measurements. In an example, the RARWD may be operating before the new object enters the region, and detecting the new object in the region may comprise monitoring, e.g. scanning, the region until the new object is detected. In other embodiments the RARWD may be triggered to monitor, e.g. scan, the region for the new object in response to a triggering event representing a detected motion or a detected presence of an object in and/or adjacent the region. In some embodiments, a spatial location within a monitored region of a detector that detected the motion or presence may be undeterminable from the detected motion or presence, or more particularly a detected motion. The method may comprise determining whether the object is human based on the second set of RARWD measurements, e.g. by determining at least one property and/or at least one profile of properties of the RARWD measurements that is indicative of a human, or by any other suitable technique.

The triggering event may be detected using the RARWD (e.g. using doppler motion detection) in some embodiments or by a different device in other embodiments. The different device may, for example, comprise a passive infrared (PIR) motion detector.

The system may be configured to one or both of: collect the first set of measurements and/or learn at least one reference location under comparable contextual conditions to one or both of: collecting and/or receiving the second set of measurements and/or determining from the second set of RARWD measurements the current location. The comparable contextual conditions may, for example, comprise being during a same time of day. Thus, for example, what constitutes an acceptable boundary crossing at one time of day may at a different time of day not constitute an acceptable boundary crossing. The comparable contextual conditions may comprise having a comparable occupancy level or status prior to entry. Thus, for example, what constitutes an acceptable entry detection region may be dependent on whether a premises is determined to be occupied prior to entry.

In examples, at certain times the acceptable entry detection region may be different to other times. For example, entry through a rear door late at night, when the rear door is not normally used, may trigger an alarm during that time period, but not at other times.

The system may be configured to directly determine one or both of the at least one acceptable entry detection region and/or the at least one unacceptable entry detection region. That is, the system may be configured to determine one or both of the at least one acceptable entry detection region and/or the at least one unacceptable entry detection region by observing one or more example scenes representing an acceptable (or unacceptable) entry and determining an acceptable (or unacceptable) entry detection region corresponding thereto.

By contrast, one of the at least one acceptable entry detection region and/or the at least one unacceptable entry detection region may be derived using the other, optionally by subtracting it from the monitored region. For example, the at least one acceptable entry detection region may be directly determined and the at least one unacceptable entry detection region may be determined as being any part of the monitored region that is not comprised in the at least one acceptable entry detection region. The at least one unacceptable entry detection region may, in this example, therefore, be considered to be indirectly determined, i.e. by inference. In other examples, the at least one unacceptable entry detection region may be directly determined and the at least one acceptable entry detection region may be determined as being any part of the monitored region that is not comprised in the at least one acceptable entry detection region.

The system may be configured such that the directly determining the at least one acceptable entry detection region comprises identifying an object having a predefined character, e.g. based on known measurement parameters associated with the object. Examples of such known measurement parameters associated with the object may comprise at least one of: a radar cross section, kinematic behavior (e.g. moving in a certain way), intensity of a measured signal represented in the RARWD measurements, Doppler value, and/or the like. For example, an installer or other user may locate or move the object to identify at least one acceptable entry detection region or at least one unacceptable entry detection region, and the system may be configured to determine that at least one acceptable entry detection region by identifying the object and/or the location of the object in the RARWD measurements.

In some embodiments the object may be a human, e.g. an installer. In some embodiments the object may be a reflective device for the RARWD, e.g. a retroreflector. In some embodiments, the system may be configured to determine that at least one acceptable entry detection region by tracking the object to define a path traversed by the object over a period of time, and determining an acceptable entry detection based on the path traversed.

Additionally, or alternatively, the system may be configured to determine at least one acceptable entry detection region by determining a location of the object and determining an acceptable entry detection region as comprising a region surrounding and/or adjacent the object, e.g. adjacent the object on a nearest side to the RARWD.

The object may be used to signal the position and one or more dimensions (e.g. width and optionally other dimensions) of the acceptable boundary crossing. In such an application, the system may be configured to determine the acceptable entry detection region based on a determined position and dimensions of the acceptable boundary crossing. The acceptable entry detection region may comprise a buffer zone with respect to the acceptable boundary crossing. The buffer zone may for example account for an expected maximum lag between a person crossing the acceptable boundary crossing and a person being detectable in the second set of RARWD measurements.

According to a second aspect of the present disclosure is a method for monitoring a region to detect an intrusion into a region having a boundary that includes one or more acceptable boundary crossings that constitute some of the boundary wherein the region is enterable via said one or more acceptable boundary crossings, the method comprising: receiving a first set of Ranging Active Reflective Wave Detector (RARWD) measurements from a RARWD configured to observe the region; from the first set of RARWD measurements, identifying at least one acceptable entry detection region that defines where an object entering the region via an acceptable boundary crossing is expected to be first detectable upon entering the region; receiving a second set of RARWD measurements to monitor for an intrusion into the region; identifying from the second set of RARWD measurements a current location of first appearance of an object entering the region, the current location comprising a position in space; determining whether an object has entered the region via an anomalous entry location based on a position of the current location of first appearance with respect to the at least one acceptable entry detection region; and responsive to determining that an object has entered the region via an anomalous entry location, controlling an output to signal an occurrence of an anomalous entry event.

The at least one acceptable entry detection region may define where a human is expected to be first detectable from RARWD measurements upon entering the region via an acceptable boundary crossing.

In embodiments described herein, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), a location of first appearance of an object entering the region, and defining where a human is expected to be first detectable from RARWD measurements upon entering the region via an acceptable boundary crossing may more generally be defining where an object entering the region via an acceptable boundary crossing is expected to be first detectable upon entering the region. The location of first appearance of an object entering the region may comprise a location of an event indicative of first appearance of a human entering the region, e.g. a door opening or the like.

The second set of RARWD measurements may be collected after the first set of RARWD measurements. The second set of RARWD measurements may be received after receiving the first set of RARWD measurements. The second set of RARWD measurements may be later measurements than the first set of RARWD measurements.

The method may comprise using the system of the first aspect. The method may comprise implementing at least one feature of the system of the first aspect.

The identifying of the at least one acceptable entry detection region may comprise learning at least one reference location of first appearance of a human in the first set of RARWD measurements for an entry into the region. Each of the at least one reference locations may comprise a position in space. The at least one acceptable entry detection region may comprise or be otherwise defined with respect to the at least one reference location of first appearance.

The region (i.e. the region monitored by the RARWD) may comprise an entirety or a part of an interior of a building. The interior may be, for example, a home or a business premises. The interior may be closable by one or more doors. The interior may correspond to an interior of the home or business premises. The region may comprise one or more rooms of the building. In examples, the region may comprise an outdoors region. The outdoors region may be defined by one or more virtual fences, and/or a range of the RARWD.

The region monitored by the RARWD may comprise an interior space within a physical structure, the physical structure being closable by having one or more physical barriers not intended to be passed through by a human; and may additionally comprise one or more external regions to the physical structure that are at least sometimes visible to the RARWD, e.g. sometimes visible if an opening such as a door, shutter or window is opened. In some embodiments the region monitored by the RARWD may be limited to a region with a software-defined virtual fence, e.g. to ensure the monitored region is confined to within the interior space, if so desired.

The method may comprise identifying the at least one acceptable entry detection region based on one or more entries to the region that change an occupancy of the monitored region from unoccupied to occupied. Optionally, the method may comprise, when identifying the at least one acceptable entry detection region, excluding entries to the monitored region whilst the monitored region is already occupied or for which an immediately prior occupancy status of the monitored region is unknown.

The boundary may also include at least one unacceptable boundary crossing, wherein the region is also enterable by a human via said at least one unacceptable boundary crossing. In some embodiments, a human can enter the region via the at least one unacceptable boundary crossing to be first detected at a location outside said at least one acceptable entry detection region. The method may comprise identifying at least one unacceptable entry detection region. The at least one unacceptable entry detection region may define where a human is expected to be first detectable from RARWD measurements upon entering the region via the at least one unacceptable boundary crossing. The identifying of whether a person has entered the region via an anomalous entry location may be based, at least in part, on a position of the current location of first appearance with respect to the at least one unacceptable entry detection region. The identifying of whether a person has entered the region via an anomalous entry location may comprise determining whether the current location is within any of the at least one unacceptable entry detection regions. In response to the identifying that the current location is within any of the at least one unacceptable entry detection regions the method may comprise identifying that a person has entered the region via an anomalous entry location.

The method may comprise identifying the at least one acceptable entry detection region so as to be agnostic to a prior occupancy status of the monitored region. This identifying the at least one acceptable entry detection region may include entries to the interior whilst the monitored region is already occupied or for which an immediately prior occupancy status of the monitored region is unknown.

At least part or all of the boundary is a provided by a feature of the environment, such as a physical feature of the environment, e.g. a wall of a building. Likewise, the acceptable boundary crossings also be provided by a feature of the environment that acts as an access point or opening, such as a doorway or passageway.

At least one acceptable boundary crossing may correspond to a doorway. At least one acceptable boundary crossing may correspond to a gateway or other entrance. At least one acceptable boundary crossing may correspond to an opening into the region from another region. At least part of the boundary, other than the at least one acceptable boundary crossing, may correspond to a wall or other physical barrier. That is, at least part of the region being monitored, other than the at least one acceptable boundary crossing, may be bounded by a wall of other physical barrier through which the waves emitted by the RARWD can't pass. The opening may comprise a passageway, a corridor, an opening in a wall, or the like. At least one unacceptable boundary crossing may be provided by a feature of the environment that can act as an access point to the region, but for which access to the region is not intended. For example, the at least one unacceptable boundary crossing may correspond to a window.

The boundary may include edges of an RARWD field of view, which may include one or more acceptable boundary crossings of the boundary. Optionally all of the edges of the RARWD field of view, or at least all of the lateral edges of the RARWD, may be acceptable boundary crossings. This may be the case, for example, in embodiments where any occupancy status of the monitored region is unknown.

The position in space may be a position of a point, for example a center within the human. The center may, for example, be or be based on a weighted center of the measurement points associated with the human.

The first set of RARWD measurements and/or the second set of RARWD measurements may comprise one or more measurement frames, e.g. a plurality of measurement frames, each measurement frame of the plurality of measurement frames being for a different time or time period. A location of first appearance of a human in RARWD measurements for an entry into the region may comprise a location in an earliest measurement frame in which the human is detectable for a given instance of the human entering the region.

A location of first appearance of a human in RARWD measurements for an entry into the region may comprise a location based on an earliest set of measurement frames in which the human is detectable for a given instance of the human entering the region. The earliest set may comprise a predetermined number of successive measurement frames or a number of measurement frames recorded during predetermined maximum period of time (e.g. 1 second).

The method may comprise, after a person is first detected in the region from the second RARWD measurements, receiving further RARWD measurements and from the further RARWD measurements track a position of the person. The method may comprise, conditional upon having determined that the person has not entered the region via an anomalous entry location, the person can, while being tracked, travel to the anomalous entry location without causing signaling of an occurrence of an anomalous entry event.

The at least one reference location of first appearance of a human in RARWD measurements for an entry into the region may comprise a plurality of reference locations of first appearance of a human in RARWD measurements for a respective plurality of entries into the region. In some embodiments, the human need not be the same human.

The determining of whether a person has entered the region via an anomalous entry location may comprise determining whether the current location fails to have a requisite spatial proximity relationship with respect to the at least one reference location of first appearance.

The method may comprise configuring the RARWD such that the region observed by the RARWD may be an entire region from which the RARWD is configured to detect reflected waves. In other embodiments the region observed by the RARWD may be a region within a virtual fence. The method may comprise defining the virtual fence as a defined sub-region of an entire region from which the RARWD is configured to detect reflected waves.

The method may comprise defining the position in space of the reference location with respect to multiple, optionally three, orthogonal coordinates. The coordinates may for example be cartesian, polar or spherical coordinates. In the case of polar or spherical coordinates, a radial coordinate may be represented as a distance coordinate or it may map to a distance (e.g. a time of flight, etc.).

The method may comprise, or be comprised in, operation of an alarm system. In some embodiments, the method may be performed while the alarm system is not in an armed state. The first set of RARWD data may optionally comprise a plurality of subsets of frames of RARWD data, each subset corresponding to a different period of time. The method may comprise determining each of the at least one reference locations from respective ones of the plurality of the subsets.

Each acceptable entry detection region may comprise at least one reference location of first appearance of a human. Having the requisite proximity relationship may comprise that the current location of first appearance is within an acceptable entry detection region. Each acceptable entry detection region may comprise at least a predefined number of the reference locations of first appearance.

Additionally, or alternatively, having the requisite proximity relationship may comprise that the current location of first appearance is part of a spatial cluster of locations, the spatial cluster including at least a predefined number of the reference locations of first appearances.

In either case, in some embodiments, the predefined number is one. Thus, even if, from the first set of reference data, a person only appears once at a certain reference location, that reference location may be sufficient to define an acceptable entry detection region.

In other embodiments the predefined number may be two or more. Thus, an acceptable entry detection region may in this case more empirically represent an observed pattern or an observed habit of entering the region.

The method may comprise calculating the predefined number. Optionally the predefined number may be dependent on a total number of the at least one reference locations. The method may comprise calculating, the predefined number to represent a minimum required likelihood for a person's first appearance in the region to be in a given detection region in order to define that given detection region as an acceptable entry detection region.

The method may comprise determining that an acceptable entrance-behavior condition is satisfied when the current location of first appearance corresponds to at least one acceptable entry detection region. The method may comprise, in response to the current location of first appearance not corresponding to any of the at least one reference location of first appearance, determining an acceptable entrance-behavior condition not to be satisfied.

The method may comprise controlling the output of an alarm system by generating the output when the acceptable entrance-behavior condition is determined to be satisfied and/or when an acceptable entrance-behavior condition is determined not to be satisfied.

The controlling of the output to signal the occurrence of an anomalous entry event may comprise generating an alarm. The alarm may comprise an audible and/or visual signal. Controlling the output to signal the occurrence of an anomalous entry event may comprise requesting performance of a verification action, e.g. using at least one verification device such as a camera, a motion sensor, an audio sensor, a door or window opening sensor, a presence sensor, and/or the like. The method may comprise generating an alarm subject to both the determination that a person has entered the region via an anomalous entry location and the verification action providing a confirmation result.

Controlling the output to signal the occurrence of an anomalous entry event may additionally or alternatively comprise indicating to another device, optionally wirelessly, that anomalous entry event has occurred. The indicating that anomalous entry event has occurred may comprise transmitting a message to indicate an occurrence of an anomalous event. Alternatively, the method may comprise transmitting an entry detected message upon detecting an entry and, conditional upon the person being determined to have entered the region not via an anomalous entry location, transmitting a non-anomalous entry message, wherein the indicating that an anomalous entry event has occurred comprises not transmitting the non-anomalous entry message.

As noted above, the identifying of the at least one acceptable entry detection region may comprise learning at least one reference location of first appearance of a human in the first set of RARWD measurements for an entry into the region.

The learning of the at least one reference location of first appearance of a human may comprise identifying all locations of first appearances of a human during a training period. The training period may be predetermined, but in other embodiments may be dynamically determined, e.g. it may last until some requirement is met, e.g. until a minimum number of first reference locations has been identified. The learning may employ any suitable learning algorithm as would be known by the person skilled in the art.

Identifying the at least one reference location of first appearance of a human may comprise detecting a new object in the region based on the first set of RARWD measurements. The method may comprise operating the RARWD before the new object enters the region, and detecting the new object in the region may comprise monitoring the region until the new object is detected. The method may comprise triggering the RARWD to monitor the region for the new object in response to a triggering event representing a detected motion or a detected presence of an object in and/or adjacent the region. In some embodiments, a spatial location within a monitored region of a detector that detected the motion or presence may be undeterminable from the detected motion or presence, or more particularly a detected motion. The method may comprise determining whether the object is human based on the second set of RARWD measurements, e.g. by determining at least one property and/or at least one profile of properties of the RARWD measurements that is indicative of a human, or by any other suitable technique.

The triggering event may be detected using the RARWD (e.g. using doppler motion detection) in some embodiments or by a different device in other embodiments. The different device may, for example, comprise a passive infrared (PIR) motion detector.

The method may comprise one or both of: collecting the first set of measurements and/or learning at least one reference location under comparable contextual conditions to one or both of: collecting the second set of measurements and/or determining from the second set of RARWD measurements the current location. The comparable contextual conditions may, for example, comprise being during a same time of day. The comparable contextual conditions may comprise having a comparable occupancy level or status prior to entry. In examples, at certain times the acceptable entry detection region may be different to other times.

The method may comprise directly determining one or both of the at least one acceptable entry detection region and/or the at least one unacceptable entry detection region. The method may comprise deriving one of the at least one acceptable entry detection region and/or the at least one unacceptable entry detection region using the other, optionally by subtracting it from the monitored region. For example, the method may comprise directly determining the at least one acceptable entry detection region and determining the at least one unacceptable entry detection region as being any part of the monitored region that is not comprised in the at least one acceptable entry detection region. In other examples, the method may comprise directly determining the at least one unacceptable entry detection region and determining the at least one acceptable entry detection region as being any part of the monitored region that is not comprised in the at least one acceptable entry detection region.

The directly determining the at least one acceptable entry detection region may comprise identifying an object having a predefined character, e.g. based on known measurement parameters associated with the object. The method may comprise locating or a moving object to identify at least one acceptable entry detection region or at least one unacceptable entry detection region. The method may comprise determining the at least one acceptable entry detection region by identifying the object and/or the location of the object in the RARWD measurements.

In some embodiments the object may be a human, e.g. an installer. In some embodiments the object may be a reflective device for the RARWD, e.g. a retroreflector. In some embodiments, method may comprise determining that at least one acceptable entry detection region by tracking the object to define a path traversed by the object over a period of time, and determining an acceptable entry detection based on the path traversed.

The method may comprise determining at least one acceptable entry detection region by determining a location of the object and determining an acceptable entry detection region as comprising a region surrounding and/or adjacent the object, e.g. adjacent the object on a nearest side to the RARWD.

The method may comprise using the object to signal the position and one or more dimensions (e.g. width and optionally other dimensions) of the acceptable boundary crossing. The method may comprise determining the acceptable entry detection region based on a determined position and dimensions of the acceptable boundary crossing. The acceptable entry detection region may comprise a buffer zone with respect to the acceptable boundary crossing. The buffer zone may for example account for an expected maximum lag between a person crossing the acceptable boundary crossing and a person being detectable in the second set of RARWD measurements.

According to a third aspect of the present disclosure is a computer program product configured such that when executed by a system comprising at least one processor, causes the system to monitor a region to detect an intrusion into a region having a boundary that includes one or more acceptable boundary crossings that constitute some of the boundary wherein the region is enterable via said one or more acceptable boundary crossings, wherein the monitoring comprises: receiving a first set of Ranging Active Reflective Wave Detector (RARWD) measurements from a RARWD configured to observe the region; from the first set of RARWD measurements, identifying at least one acceptable entry detection region that defines where an object entering the region via an acceptable boundary crossing is expected to be first detectable upon entering the region; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one acceptable entry detection region; and responsive to determining that an object has entered the region via an anomalous entry location, controlling an output to signal an occurrence of an anomalous entry event.

The at least one acceptable entry detection region may define where a human is expected to be first detectable from RARWD measurements upon entering the region via an acceptable boundary crossing.

The computer program product may be configured to implement the method of the second aspect. The computer program product may be embodied on a tangible, non-transient carrier medium.

According to a fourth aspect of the present disclosure is a system for monitoring a region, the system comprising at least one processor and configured to: receive a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; receive a second set of RARWD measurements to monitor for an intrusion into the region; identify from the second set of RARWD measurements a current location of first appearance of an object entering the region, the current location comprising a position in space; determine whether an object has entered the region via an anomalous entry location based on a position of the current location of first appearance with respect to the at least one reference location of first appearance; and responsive to determining that an object has entered the region via an anomalous entry location, control an output to signal an occurrence of an anomalous entry event.

In embodiments described herein, the object may more specifically be a human. For such embodiments, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), and a location of first appearance of an object entering the region. The location of first appearance of an object entering the region may comprise a location of an event indicative of first appearance of a human entering the region, e.g. a door opening, an object being thrown through a window, or the like

The at least one reference location may be a reference location of first appearance of a human in RARWD measurements for an entry into the region.

The identifying of the at least one reference location may comprise learning the at least one reference location from the first set of RARWD measurements. The identifying of the at least one reference location may comprise sending the first set of RARWD measurements or data derived therefrom to a remote computing system that is configured to learn the at least one reference location from the first set of RARWD measurements or the data derived therefrom; and receiving the at least one reference location from the remote computing system. Alternatively, the learning may be done by the system itself from the first set of RARWD measurements.

The second set of RARWD measurements may be collected after the first set of RARWD measurements. The second set of RARWD measurements may be received after receiving the first set of RARWD measurements. The second set of RARWD measurements may be later measurements than the first set of RARWD measurements.

The position in space may be a position of a point, for example a center within the human. The center may, for example, be or be based on a weighted center of the measurement points associated with the human.

The first set of RARWD measurements and/or the second set of RARWD measurements may comprise one or more measurement frames, e.g. a plurality of measurement frames, each measurement frame of the plurality of measurement frames being for a different time or time period. A location of first appearance of a human in RARWD measurements for an entry into the region may comprise a location in an earliest measurement frame in which the human is detectable for a given instance of the human entering the region.

A location of first appearance of a human in RARWD measurements for an entry into the region may comprise a location based on an earliest set of measurement frames in which the human is detectable for a given instance of the human entering the region. The earliest set may comprise a predetermined number of successive measurement frames or a number of measurement frames recorded during predetermined maximum period of time (e.g. 1 second).

With each “location”, as used herein, comprising as a position in space, a spatial relationship (e.g. a distance) between different locations is determinable.

The system may be configured such that, after a person is first detected in the region from the second RARWD measurements, the system is configured to receive further RARWD measurements and from the further RARWD measurements track a position of the person. The system may be configured such that, conditional upon having determined that the person has not entered the region via an anomalous entry location, the person can, while being tracked, travel to the anomalous entry location without causing the output to signal an occurrence of an anomalous entry event. In other words, the system may be configured such that, conditional upon determining that the person has not entered the region via an anomalous entry location, said tracking of the position of the person does not, in response to the tracked position thereafter indicating that the person has travelled to the anomalous entry location, cause the output to signal an occurrence of an anomalous entry.

The at least one reference location of first appearance of a human in RARWD measurements for an entry into the region may comprise a plurality of reference locations of first appearance of a human in RARWD measurements for a respective plurality of entries into the region. In some embodiments, the human need not be the same human.

The system may be configured such that the determining of whether a person has entered the region via an anomalous entry location based on a position of the current location with respect to the at least one reference location of first appearance comprises determining whether the current location fails to have a requisite spatial proximity relationship with respect to the at least one reference location of first appearance.

The RARWD may be configured such that the region observed by the RARWD may be an entire region from which the RARWD is configured to detect reflected waves. In other embodiments the region observed by the RARWD may be a region within a virtual fence. The virtual fence may be a defined sub-region of an entire region from which the RARWD is configured to detect reflected waves. This may be especially useful in outdoor applications, or other installations where one or more boundary crossings of a boundary of the region, or all of the boundary, may be unbound by physical barriers. Optionally the region may be bound by one or more physical structures, e.g. walls, windows, doors, etc., and/or one or more boundaries of what the RARWD can or could detect without physically obstructing structures.

The position in space of the reference location may be defined with respect to multiple, optionally three, orthogonal coordinates. The coordinates may for example be cartesian, polar or spherical coordinates. In the case of polar or spherical coordinates, a radial coordinate may be represented as a distance coordinate or it may map to a distance (e.g. a time of flight, etc.).

The system may be, or comprise, or be configured to, operate an alarm system. In some embodiments, the system, or the alarm system, is operable as outlined herein while not in an armed state. Optionally the system, or the alarm system, may operate without arming states. The first set of RARWD data may optionally comprise a plurality of subsets of frames of RARWD data, each subset corresponding to a different period of time. Optionally each of the at least one reference locations may be determined from respective ones of the plurality of the subsets.

In some embodiments, the system may be configured to define, or receive a definition of, at least one acceptable entry detection region, each acceptable entry detection region comprising a reference location of first appearance of a human. Having the requisite proximity relationship may comprise that the current location of first appearance is within an acceptable entry detection region. Each acceptable entry detection region may comprise at least a predefined number of the reference locations of first appearance.

Additionally, or alternatively, having the requisite proximity relationship may comprise that the current location of first appearance is part of a spatial cluster of locations, the spatial cluster including at least a predefined number of the reference locations of first appearances.

In either case, in some embodiments, the predefined number is one. Thus, even if, from the first set of reference data, a person only appears once at a certain reference location, that reference location may be sufficient to define an acceptable entry detection region.

In other embodiments the predefined number may be two or more. Thus, an acceptable entry detection region may in this case more empirically represent an observed pattern or an observed habit of entering the region.

The system may be configured to calculate the predefined number. Optionally the predefined number may be dependent on a total number of the at least one reference locations. Thus, the predefined number may, for example, be calculated to represent a minimum required likelihood for a person's first appearance in the region to be in a given detection region in order to define that given detection region as an acceptable entry detection region.

The system may be configured to determine that acceptable entrance-behavior condition is satisfied when the current location of first appearance corresponds to at least one acceptable entry detection region. In some embodiments, the system may be configured such that, in response to the current location of first appearance not corresponding to any of the at least one reference location of first appearance, an acceptable entrance-behavior condition is determined not to be satisfied.

The system may be configured to control the output by generating the output when the acceptable entrance-behavior condition is determined to be satisfied and/or when an acceptable entrance-behavior condition is determined not to be satisfied. For example, the non-provision of an output, e.g. in response to the receipt of the second set of RARWD measurements, may be indicative of occurrence of an anomalous entry event in examples that comprise generating the output when the acceptable entrance-behavior condition is determined to be satisfied, particularly in embodiments in which another device awaits the output to determine by, receiving the output, that an anomalous entry event has not occurred. In other examples, provision of an output, e.g. in response to the receipt of the second set of RARWD measurements, may be indicative of occurrence of an anomalous entry event in examples that comprise generating the output when the acceptable entrance-behavior condition is determined not to be satisfied. In examples, the output may contain data or a signal indicative of whether the acceptable entrance-behavior condition is determined to be satisfied or not satisfied.

Controlling the output to signal the occurrence of an anomalous entry event may comprise generating an alarm. The alarm may comprise an audible and/or visual signal. Controlling the output to signal the occurrence of an anomalous entry event may comprise requesting performance of a verification action, e.g. using at least one verification device such as a camera, a motion sensor, an audio sensor, a door or window opening sensor, a presence sensor, and/or the like. The system may be configured to generate an alarm subject to both the determination that a person has entered the region via an anomalous entry location and the verification action providing a confirmation result.

Controlling the output to signal the occurrence of an anomalous entry event may additionally or alternatively comprise the system indicating to another device, optionally wirelessly, that anomalous entry event has occurred. The indicating that anomalous entry event has occurred may comprise the system transmitting a message to indicate an occurrence of an anomalous event. Alternatively, the method may comprise the system transmitting an entry detected message upon detecting an entry and, conditional upon the person being determined to have entered the region not via an anomalous entry location, transmitting a non-anomalous entry message, wherein the indicating that an anomalous entry event has occurred comprises not transmitting the non-anomalous entry message.

As noted above, the determining by the system of the at least one acceptable entry detection region may comprise learning at least one reference location of first appearance of a human in the first set of RARWD measurements for an entry into the region.

The learning of the at least one reference location of first appearance of a human may comprise identifying all locations of first appearances of a human during a training period. The training period may be predetermined, but in other embodiments may be dynamically determined, e.g. it may last until some requirement is met, e.g. until a minimum number of first reference locations has been identified.

Learning the at least one reference location of first appearance of a human may comprise detecting a new object in the region based on the first set of RARWD measurements. In an example, the RARWD may be operating before the new object enters the region, and detecting the new object in the region may comprise monitoring, e.g. scanning, the region until the new object is detected. In other embodiments the RARWD may be triggered to monitor, e.g. scan, the region for the new object in response to a triggering event representing a detected motion or a detected presence of an object in and/or adjacent the region. In some embodiments, a spatial location within a monitored region of a detector that detected the motion or presence may be undeterminable from the detected motion or presence, or more particularly a detected motion. The method may comprise determining whether the object is human based on the second set of RARWD measurements, e.g. by determining at least one property and/or at least one profile of properties of the RARWD measurements that is indicative of a human, or by any other suitable technique.

The triggering event may be detected using the RARWD (e.g. using doppler motion detection) in some embodiments or by a different device in other embodiments. The different device may, for example, comprise a passive infrared (PIR) motion detector.

The system may be configured to one or both of: perform the first set of measurements and/or learn at least one reference location under comparable contextual conditions to one or both of: performing the second set of measurements; and/or determining from the second set of RARWD measurements the current location. The comparable contextual conditions may, for example, comprise being during a same time of day. Thus, for example, what constitutes an acceptable boundary crossing at one time of day may at a different time of day not constitute an acceptable boundary crossing. The comparable contextual conditions may comprise having a comparable occupancy level or status prior to entry. Thus, for example, what constitutes an acceptable entry detection region may be dependent on whether a premises is determined to be occupied prior to entry.

In examples, at certain times the acceptable entry detection region may be different to other times. For example, entry through a rear door late at night, when the rear door is not normally used, may trigger an alarm during that time period, but not at other times.

According to a fifth aspect of the present disclosure is a computer-implemented method of monitoring a region to detect an intrusion, the method comprising: receiving a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; after receiving the first set of RARWD measurements, receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one reference location of first appearance; and responsive to determining that an object has entered the region via an anomalous entry location, controlling an output to signal an occurrence of an anomalous entry event.

In embodiments described herein, the object may more specifically be a human. For such embodiments, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), and a location of first appearance of an object entering the region. The location of first appearance of an object entering the region may comprise a location of an event indicative of first appearance of a human entering the region, e.g. a door opening or the like

The second set of RARWD measurements may be collected after the first set of RARWD measurements. The second set of RARWD measurements may be received after receiving the first set of RARWD measurements. The second set of RARWD measurements may be later measurements than the first set of RARWD measurements.

The at least one reference location may be at least one reference location of a first appearance of a human in RARWD measurements for an entry into the region.

The identifying of the at least one reference location may comprise learning the at least one reference location from the first set of RARWD measurements. The identifying of the at least one reference location may comprise sending the first set of RARWD measurements or data derived therefrom to a remote computing system that is configured to learn the at least one reference location from the first set of RARWD measurements or the data derived therefrom; and receiving the at least one reference location from the remote computing system. Alternatively, the learning may be done locally from the first set of RARWD measurements.

The method may comprise collecting the second set of RARWD measurements after the first set of RARWD measurements. The method may comprise receiving the second set of RARWD measurements after receiving the first set of RARWD measurements. The second set of RARWD measurements may be later measurements than the first set of RARWD measurements.

The position in space may be a position of a point, for example a center within the human. The center may, for example, be or be based on a weighted center of the measurement points associated with the human.

The first set of RARWD measurements and/or the second set of RARWD measurements may comprise one or more measurement frames, e.g. a plurality of measurement frames, each measurement frame of the plurality of measurement frames being for a different time or time period. A location of first appearance of a human in RARWD measurements for an entry into the region may comprise a location in an earliest measurement frame in which the human is detectable for a given instance of the human entering the region.

A location of first appearance of a human in RARWD measurements for an entry into the region may comprise a location based on an earliest set of measurement frames in which the human is detectable for a given instance of the human entering the region. The earliest set may comprise a predetermined number of successive measurement frames or a number of measurement frames recorded during predetermined maximum period of time (e.g. 1 second).

With each “location”, as used herein, comprising as a position in space, a spatial relationship (e.g. a distance) between different locations is determinable.

The method may comprise, after a person is first detected in the region from the second RARWD measurements, receiving further RARWD measurements and from the further RARWD measurements tracking a position of the person. The method may comprise, conditional upon having determined that the person has not entered the region via an anomalous entry location, the person can, while being tracked, travel to the anomalous entry location without causing the output to signal an occurrence of an anomalous entry event.

The at least one reference location of first appearance of a human in RARWD measurements for an entry into the region may comprise a plurality of reference locations of first appearance of a human in RARWD measurements for a respective plurality of entries into the region. In some embodiments, the human need not be the same human.

The method may comprise determining whether a person has entered the region via an anomalous entry location based on a position of the current location with respect to the at least one reference location of first appearance comprises determining whether the current location fails to have a requisite spatial proximity relationship with respect to the at least one reference location of first appearance.

The method may comprise configuring the RARWD such that the region observed by the RARWD may be an entire region from which the RARWD is configured to detect reflected waves. The method may comprise configuring the RARWD such that the region observed by the RARWD may be a region within a virtual fence. The virtual fence may be a defined sub-region of an entire region from which the RARWD is configured to detect reflected waves. The region may be bound by one or more physical structures, e.g. walls, windows, doors, etc., and/or one or more boundaries of what the RARWD can or could detect without physically obstructing structures.

The method may comprise defining the position in space of the reference location with respect to multiple, optionally three, orthogonal coordinates. The coordinates may for example be cartesian, polar or spherical coordinates. In the case of polar or spherical coordinates, a radial coordinate may be represented as a distance coordinate or it may map to a distance (e.g. a time of flight, etc.).

The method may comprise operating an alarm system. The method may be performed while the alarm system is in an armed state. The method may be performed while the alarm system is not in an armed state. Optionally, the alarm system, may operate without arming states. The first set of RARWD data may optionally comprise a plurality of subsets of frames of RARWD data, each subset corresponding to a different period of time. The method may comprise determining each of the at least one reference locations from respective ones of the plurality of the subsets.

The method may comprise defining, or receiving a definition of, at least one acceptable entry detection region, each acceptable entry detection region comprising a reference location of first appearance of a human. Having the requisite proximity relationship may comprise that the current location of first appearance is within an acceptable entry detection region. Each acceptable entry detection region may comprise at least a predefined number of the reference locations of first appearance.

Additionally, or alternatively, having the requisite proximity relationship may comprise that the current location of first appearance is part of a spatial cluster of locations, the spatial cluster including at least a predefined number of the reference locations of first appearances.

In either case, in some embodiments, the predefined number is one.

In other embodiments the predefined number may be two or more.

The method may comprise calculating the predefined number. Optionally the predefined number may be dependent on a total number of the at least one reference locations. The method may comprise calculating the predefined number to represent a minimum required likelihood for a person's first appearance in the region to be in a given detection region in order to define that given detection region as an acceptable entry detection region.

The method may comprise determining that acceptable entrance-behavior condition is satisfied when the current location of first appearance corresponds to at least one acceptable entry detection region. The method may comprise, in response to the current location of first appearance not corresponding to any of the at least one reference location of first appearance, an acceptable entrance-behavior condition is determined not to be satisfied.

The method may comprise controlling the output of the alarm system by generating the output when the acceptable entrance-behavior condition is determined to be satisfied and/or when an acceptable entrance-behavior condition is determined not to be satisfied. For example, the non-provision of an output, e.g. in response to the receipt of the second set of RARWD measurements, may be indicative of occurrence of an anomalous entry event in examples that comprise generating the output when the acceptable entrance-behavior condition is determined to be satisfied, particularly in embodiments in which another device awaits the output to determine by, receiving the output, that an anomalous entry event has not occurred. In other examples, provision of an output, e.g. in response to the receipt of the second set of RARWD measurements, may be indicative of occurrence of an anomalous entry event in examples that comprise generating the output when the acceptable entrance-behavior condition is determined not to be satisfied. In examples, the output may contain data or a signal indicative of whether the acceptable entrance-behavior condition is determined to be satisfied or not satisfied.

Controlling the output to signal the occurrence of an anomalous entry event may comprise generating an alarm. The alarm may comprise an audible and/or visual signal. Controlling the output to signal the occurrence of an anomalous entry event may comprise requesting performance of a verification action, e.g. using at least one verification device such as a camera, a motion sensor, an audio sensor, a door or window opening sensor, a presence sensor, and/or the like. The method may comprise generating an alarm subject to both the determination that a person has entered the region via an anomalous entry location and the verification action providing a confirmation result.

Controlling the output to signal the occurrence of an anomalous entry event may additionally or alternatively comprise m indicating to another device, optionally wirelessly, that anomalous entry event has occurred. The indicating that anomalous entry event has occurred may comprise transmitting a message to indicate an occurrence of an anomalous event. Alternatively, the method may comprise the system transmitting an entry detected message upon detecting an entry and, conditional upon the person being determined to have entered the region not via an anomalous entry location, transmitting a non-anomalous entry message, wherein the indicating that an anomalous entry event has occurred comprises not transmitting the non-anomalous entry message.

As noted above, the determining by the system of the at least one acceptable entry detection region may comprise learning at least one reference location of first appearance of a human in the first set of RARWD measurements for an entry into the region.

The learning of the at least one reference location of first appearance of a human may comprise identifying all locations of first appearances of a human during a training period. The training period may be predetermined, but in other embodiments may be dynamically determined, e.g. it may last until some requirement is met, e.g. until a minimum number of first reference locations has been identified.

Learning the at least one reference location of first appearance of a human may comprise detecting a new object in the region based on the first set of RARWD measurements. The method may comprise operating the RARWD before the new object enters the region. Detecting the new object in the region may comprise monitoring, e.g. scanning, the region until the new object is detected. The methods may comprise triggering the RARWD to monitor the region for the new object in response to a triggering event representing a detected motion or a detected presence of an object in and/or adjacent the region. In some embodiments, a spatial location within a monitored region of a detector that detected the motion or presence may be undeterminable from the detected motion or presence, or more particularly a detected motion. The method may comprise determining whether the object is human based on the second set of RARWD measurements, e.g. by determining at least one property and/or at least one profile of properties of the RARWD measurements that is indicative of a human, or by any other suitable technique.

The method may comprise detecting the triggering event using the RARWD (e.g. using doppler motion detection) in some embodiments or by a different device in other embodiments. The different device may, for example, comprise a passive infrared (PIR) motion detector.

The method may comprise one or both of: performing the first set of measurements and/or identifying at least one reference location under comparable contextual conditions to one or both of: performing the second set of measurements; and/or identifying from the second set of RARWD measurements the current location. The comparable contextual conditions may, for example, comprise being during a same time of day. The comparable contextual conditions may comprise having a comparable occupancy level or status prior to entry. In examples, at certain times the acceptable entry detection region may be different to other times.

According to a sixth aspect of the present disclosure is a computer program product configured such that when executed by a system comprising at least one processor, causes the system to monitor a region to detect an intrusion into a region having a boundary that includes one or more acceptable boundary crossings that constitute some of the boundary wherein the region is enterable via said one or more acceptable boundary crossings, the monitoring comprising: receiving a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; after receiving the first set of RARWD measurements, receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one reference location of first appearance; and responsive to determining that an object has entered the region via an anomalous entry location, controlling an output to signal an occurrence of an anomalous entry event.

In embodiments described herein, the object may more specifically be a human. For such embodiments, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), and a location of first appearance of an object entering the region. The location of first appearance of an object entering the region may comprise a location of an event indicative of first appearance of a human entering the region, e.g. a door opening or the like.

The at least one reference location may comprise at least one reference location of a first appearance of a human in RARWD measurements for an entry into the region.

The identifying of the at least one reference location may comprise learning the at least one reference location from the first set of RARWD measurements. The identifying of the at least one reference location may comprise sending the first set of RARWD measurements or data derived therefrom to a remote computing system that is configured to learn the at least one reference location from the first set of RARWD measurements or the data derived therefrom; and receiving the at least one reference location from the remote computing system. Alternatively, the learning may be done by the system itself from the first set of RARWD measurements.

The computer program product may be configured to implement the method of the fifth aspect. The computer program product may be embodied on a tangible, non-transient carrier medium.

In a seventh aspect of the present invention there is provided a method of configuring the system of the first aspect, the system comprising the RARWD that is for making one or both of the first set of RARWD measurements and/or the second set of RARWD measurements, wherein the RARWD has a field of view and the boundary of the region includes an unacceptable boundary crossing, and the method comprises installing the RARWD at a location and orientation to have the unacceptable boundary crossing within the field of view.

The unacceptable boundary crossing may correspond to a part of the boundary of the region, the part being where a window is located. The installing of the RARWD may comprise installing the RARWD at a location and orientation to have the unacceptable boundary crossing entirely within the field of view.

Preferably the field of view may include a margin on all sides of the unacceptable boundary crossing. In some embodiments, the field of view may also span one or more acceptable boundary crossings into the region. At such an acceptable boundary crossing there may for example be a door or other entry structure.

The region may be internal to a building in some embodiments. In other embodiments, the region may be in an outside environment.

An eighth aspect of the invention comprises a computer-implemented method of monitoring a region to detect an intrusion into a region having a boundary that includes one or more unacceptable boundary crossings that constitute some of the boundary wherein the region is enterable via said one or more unacceptable boundary crossings, the method comprising:
receiving a first set of Ranging Active Reflective Wave Detector (RARWD) measurements from an RARWD configured to observe the region;
from the first set of RARWD measurements, identifying at least one unacceptable entry detection region that defines where an object entering the region via an unacceptable boundary crossing is expected to be first detectable upon entering the region;
receiving a second set of RARWD measurements to monitor for an intrusion into the region;
identifying from the second set of RARWD measurements a current location of first appearance of an object entering the region, the current location comprising a position in space;
determining whether an object has entered the region via an anomalous entry location based on a position of the current location of first appearance with respect to the at least one unacceptable entry detection region; and
responsive to determining that an object has entered the region via an anomalous entry location, controlling an output to signal an occurrence of an anomalous entry event.

In embodiments described herein, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), a location of first appearance of an object entering the region, and defining where a human is expected to be first detectable from RARWD measurements upon entering the region via an unacceptable boundary crossing may more generally be defining where an object entering the region via an unacceptable boundary crossing is expected to be first detectable upon entering the region. The location of first appearance of an object entering the region may comprise a location of an event indicative of first appearance of a human entering the region, e.g. a door opening or the like.

The at least one unacceptable entry detection region may define where a human is expected to be first detectable from RARWD measurements upon entering the region via an unacceptable boundary crossing.

The second set of RARWD measurements may be collected after the first set of RARWD measurements. The second set of RARWD measurements may be received after receiving the first set of RARWD measurements. The second set of RARWD measurements may be later measurements than the first set of RARWD measurements.

The boundary may also include at least one acceptable boundary crossing, wherein the region is also enterable by a human via said at least one acceptable boundary crossing, and a human can enter the region via the at least one acceptable boundary crossing to be first detected at a location outside said at least one unacceptable entry detection region. At least one acceptable boundary crossing may be at a door. At least one unacceptable boundary crossing may be at a window.

The boundary may include edges of an RARWD field of view, which may include one or more acceptable boundary crossings of the boundary. Optionally, some or all of one or more of the edges of the RARWD field of view, or at least all of the lateral edges of the RARWD, may be acceptable boundary crossings. This may be the case, for example, in embodiments where any occupancy status of the monitored region is unknown.

Identifying one or both of the at least one acceptable entry detection region and at least one unacceptable entry detection region may comprise or consist of determining at least one unacceptable entry detection region. In such embodiments, determining whether a person has entered the region via an anomalous entry location may comprise determining whether the current location is within any of the at least one unacceptable entry detection regions, wherein in response to the determining that the current location is within any of the at least one unacceptable entry detection regions the method comprises determining that a person has entered the region via an anomalous entry location.

In some embodiments, the region may be enterable via said one or more unacceptable boundary crossings by entering via structure on a perimeter of the region wherein the structure is not a door, e.g. the structure may be a window.

The identifying at least one unacceptable entry detection region may comprise identifying an object having of a predefined character e.g. based on known measurement parameters associated with the object, for a radar cross section, kinematic behavior (e.g. moving in a certain way), intensity of a measured signal represented in the RARWD measurements, Doppler value, etc.).

In some embodiments the object may be a human, e.g. an installer. In some embodiments the object may be a reflective device for the RARWD, e.g. a retroreflector. In some embodiments, determining at least one unacceptable entry detection region may comprise tracking the object to define a path traversed by the object a period of time, and determining an unacceptable entry detection based on the path traversed.

Additionally, or alternatively, determining at least one unacceptable entry detection region may comprise determining a location of the object and determining an unacceptable entry detection region as comprising a region surrounding and/or adjacent the object, e.g. adjacent the object on a nearest side to the RARWD.

The object may be used to signal the position and one or more dimensions (e.g. width and optionally other dimensions) of the unacceptable boundary crossing. In such an application, the method may comprise determining the unacceptable entry detection region based on a determined position and dimensions of the unacceptable boundary crossing. The unacceptable entry detection region may comprise a buffer zone with respect to the unacceptable boundary crossing. The buffer zone may for example account for an expected maximum lag between a person crossing the unacceptable boundary crossing and a person being detectable in the second set of RARWD measurements.

In the case of relying upon an acceptable entry detection region to detect an anomalous entry event, having the acceptable entry detection region cover all possible locations of first appearance of a human entering via the corresponding acceptable boundary crossing may reduce the number of false anomaly detections. By contrast, in the case of relying upon an unacceptable entry detection region to detect an anomalous entry event, having the unacceptable entry detection region cover all possible locations of first appearance of a human entering via the corresponding unacceptable boundary crossing may be more beneficial, since otherwise a person may enter the region via the unacceptable boundary crossing without detecting an anomalous entry event.

For the sake of clarity, in the present method, the location of any acceptable or unacceptable boundary crossings need not be known or determined.

Any of the features described above regarding any other aspect in relation to using an acceptable entry detection region to detect an anomalous entry event may be used.

A ninth aspect of the invention comprises a system for monitoring a region to detect an intrusion into a region having a boundary that includes one or more unacceptable boundary crossings that constitute some of the boundary, wherein the region is enterable via said one or more unacceptable boundary crossings, the system comprising at least one processor and being configured to:
receive a first set of Ranging Active Reflective Wave Detector (RARWD) measurements from an RARWD configured to observe the region;
from the first set of RARWD measurements, identify at least one unacceptable entry detection region that defines where an object entering the region via an unacceptable boundary crossing is expected to be first detectable upon entering the region;
receive a second set of RARWD measurements to monitor for an intruder into the region;
identify from the second set of RARWD measurements a current location of first appearance of an object entering the region, the current location comprising a position in space;
determine whether an object has entered the region via an anomalous entry location based on a position of the current location of first appearance with respect to the at least one unacceptable entry detection region; and
responsive to determining that an object has entered the region via an anomalous entry location, control an output to signal an occurrence of an anomalous entry event.

In embodiments described herein, a location of first appearance of an object entering the region may more specifically comprise a location of first appearance of a human (e.g. in RARWD measurements, such as in a first or second set of RARWD measurements) for an entry into the region (whether a current or reference location). In some embodiments, the current location of first appearance of an object entering the region may more specifically comprise a current location of first appearance of a human entering the region, and/or identifying the current location of first appearance of an object entering may more specifically comprise identifying a current location of first appearance of a human in RARWD measurements for an entry into the region. For any of the embodiments described in such more specific terms, the more specific terms are optional. For example, the embodiments could be broadened to apply more generally to an object (instead of a human), a location of first appearance of an object entering the region, and defining where a human is expected to be first detectable from RARWD measurements upon entering the region via an unacceptable boundary crossing may more generally be defining where an object entering the region via an unacceptable boundary crossing is expected to be first detectable upon entering the region. The location of first appearance of an object entering the region may comprise a location of an event indicative of first appearance of a human entering the region, e.g. a door opening or the like

The at least one unacceptable entry detection region may comprise at least one unacceptable entry detection region that defines where a human is expected to be first detectable from RARWD measurements upon entering the region via an unacceptable boundary crossing.

The system may be configured to implement the method of the eighth aspect.

A tenth aspect of the invention comprises a computer program product configured such that, when executed by a system comprising at least one processor, causes the system to monitor a region to detect an intrusion entering a region having a boundary that includes one or more unacceptable boundary crossings that constitute some of the boundary wherein the region is enterable via said one or more unacceptable boundary crossings, the monitoring comprising:
receiving a first set of Ranging Active Reflective Wave Detector (RARWD) measurements from an RARWD configured to observe the region;
from the first set of RARWD measurements, identifying at least one unacceptable entry detection region that defines where an object entering the region via an unacceptable boundary crossing is expected to be first detectable upon entering the region;
receiving a second set of RARWD measurements to monitor for an intrusion into the region;
identifying from the second set of RARWD measurements a current location of first appearance of an object entering the region, the current location comprising a position in space;
determining whether an object has entered the region via an anomalous entry location based on a position of the current location of first appearance with respect to the at least one unacceptable entry detection region; and
responsive to determining that an object has entered the region via an anomalous entry location, controlling an output to signal an occurrence of an anomalous entry event.

The computer program product may be configured to implement the method of the eighth aspect. The computer program product may be embodied on a non-transient, physical computer readable carrier medium.

The at least one unacceptable entry detection region may comprise at least one unacceptable entry detection region that defines where a human is expected to be first detectable from RARWD measurements upon entering the region via an unacceptable boundary crossing.

An aspect of the invention may comprise a system for monitoring a region to detect an intruder entering a region having a boundary that includes one or more acceptable boundary crossings that constitute some of the boundary wherein the region is enterable via said one or more acceptable boundary crossings. The system comprises at least one processor configured to: receive a first set of Ranging Active Reflective Wave Detector (RARWD) measurements from a RARWD configured to observe the region; from the first set of RARWD measurements, identify at least one acceptable entry detection region; receive a second set of RARWD measurements to monitor for an intruder into the region; identify from the second set of RARWD measurements a current location of first appearance of a human in RARWD measurements for an entry into the region, the current location comprising a position in space; determine whether a person has entered the region via an anomalous entry location based on a position of the current location of first appearance with respect to the at least one acceptable entry detection region; and responsive to determining that a person has entered the region via an anomalous entry location, control an output to signal an occurrence of an anomalous entry event. The acceptable entry region may define where a human is expected to be first detectable from RARWD measurements upon entering the region via an acceptable boundary crossing. Any of the features described above in relation to the first example could be applied individually and separably to or in combination with the present aspect.

An aspect of the invention may comprise a computer-implemented method of monitoring a region to detect an intruder entering a region having a boundary that includes one or more acceptable boundary crossings that constitute some of the boundary wherein the region is enterable via said one or more acceptable boundary crossings. The method comprises: receiving a first set of Ranging Active Reflective Wave Detector (RARWD) measurements made by a RARWD configured to observe the region; from the first set of RARWD measurements, identifying at least one acceptable entry detection region; receiving a second set of RARWD measurements to monitor for an intruder into the region; determining from the second set of RARWD measurements a current location of first appearance of a human in the second set of RARWD measurements for an entry into the region, the current location comprising a position in space; determining whether a person has entered the region via an anomalous entry location based on a position of the current location of first appearance with respect to the at least one acceptable entry detection region; and responsive to determining that a person has entered the region via an anomalous entry location, controlling an output to signal an occurrence of an anomalous entry event.

An aspect of the invention may comprise a tangible, non-transient computer readable carrier medium carrying a computer program product configured such that when executed by a system comprising at least one processor, causes the system to monitor a region to detect an intruder entering a region having a boundary that includes one or more acceptable boundary crossings that constitute some of the boundary, wherein the region is enterable via said one or more acceptable boundary crossings. The monitoring may comprise: receiving a first set of Ranging Active Reflective Wave Detector (RARWD) measurements from a RARWD configured to observe the region; from the first set of RARWD measurements, identifying at least one acceptable entry detection region; receiving a second set of RARWD measurements to monitor for an intruder into the region; determining from the second set of RARWD measurements a current location of first appearance of a human in RARWD measurements for an entry into the region, the current location comprising a position in space; determining whether a person has entered the region via an anomalous entry location based on a position of the current location of first appearance with respect to the at least one acceptable entry detection region; and responsive to determining that a person has entered the region via an anomalous entry location, controlling an output to signal an occurrence of an anomalous entry event.

An aspect of the invention may comprise a system for monitoring a region to detect an intruder, the system comprising at least one processor and configured to: receive a first set of Ranging Active Reflective Wave Detector (RARWD) measurements for a region observed by an RARWD; from the first set of RARWD measurements, identifying at least one reference location of first appearance of a human in RARWD measurements for an entry into the region, each of the at least one reference locations comprising a position in space; receive a second set of RARWD measurements to monitor for an intruder into the region; determine from the second set of RARWD measurements a current location of first appearance of a human in RARWD measurements for an entry into, the current location comprising a position in space; determine whether a person has entered the region via an anomalous entry location based on a position of the current location of first appearance with respect to the at least one reference location of first appearance; and responsive to determining that a person has entered the region via an anomalous entry location, control an output to signal an occurrence of an anomalous entry event.

An aspect of the invention may comprise a computer-implemented method of monitoring a region to detect an intruder, the method comprising: receiving a first set of Ranging Active Reflective Wave Detector (RARWD) measurements for a region observed by an RARWD; from the first set of RARWD measurements, identifying at least one reference location of first appearance of a human in RARWD measurements for an entry into the region, each of the at least one reference locations comprising a position in space; receiving a second set of RARWD measurements to monitor for an intruder into the region; determining from the second set of RARWD measurements a current location of first appearance of a human in RARWD measurements for an entry into, the current location comprising a position in space; determining whether a person has entered the region via an anomalous entry location based on a position of the current location of first appearance with respect to the at least one reference location of first appearance; and responsive to determining that a person has entered the region via an anomalous entry location, controlling an output to signal an occurrence of an anomalous entry event.

An aspect of the invention may comprise a tangible, non-transient computer readable carrier medium carrying a computer program product configured such that when executed by a system comprising at least one processor, causes the system to monitor a region to detect an intruder, the monitoring comprising: receiving a first set of Ranging Active Reflective Wave Detector (RARWD) measurements for a region observed by an RARWD; from the first set of RARWD measurements, identifying at least one reference location of first appearance of a human in RARWD measurements for an entry into the region, each of the at least one reference locations comprising a position in space; receiving a second set of RARWD measurements to monitor for an intruder into the region; determining from the second set of RARWD measurements a current location of first appearance of a human in RARWD measurements for an entry into, the current location comprising a position in space; determining whether a person has entered the region via an anomalous entry location based on a position of the current location of first appearance with respect to the at least one reference location of first appearance; and responsive to determining that a person has entered the region via an anomalous entry location, controlling an output to signal an occurrence of an anomalous entry event.

An aspect of the invention may comprise a computer-implemented method of monitoring a region to detect an intruder entering a region having a boundary that includes one or more unacceptable boundary crossings that constitute some of the boundary wherein the region is enterable via said one or more unacceptable boundary crossings, the method comprising: receiving a first set of Ranging Active Reflective Wave Detector (RARWD) measurements from an RARWD configured to observe the region; from the first set of RARWD measurements, identifying at least one unacceptable entry detection region; receiving a second set of RARWD measurements to monitor for an intruder into the region; determining from the second set of RARWD measurements a current location of first appearance of a human in RARWD measurements for an entry into the region, the current location comprising a position in space; determining whether a person has entered the region via an anomalous entry location based on a position of the current location of first appearance with respect to the at least one unacceptable entry detection region; and responsive to determining that a person has entered the region via an anomalous entry location, controlling an output to signal an occurrence of an anomalous entry event.

An aspect of the invention may comprise a system for monitoring a region to detect an intruder entering a region having a boundary that includes one or more unacceptable boundary crossings that constitute some of the boundary, wherein the region is enterable via said one or more unacceptable boundary crossings, the system comprising at least one processor and being configured to: receive a first set of Ranging Active Reflective Wave Detector (RARWD) measurements from an RARWD configured to observe the region; from the first set of RARWD measurements, determine at least one unacceptable entry detection region; receive a second set of RARWD measurements to monitor for an intruder into the region; determine from the second set of RARWD measurements a current location of first appearance of a human in RARWD measurements for an entry into the region, the current location comprising a position in space; determine whether a person has entered the region via an anomalous entry location based on a position of the current location of first appearance with respect to the at least one unacceptable entry detection region; and responsive to determining that a person has entered the region via an anomalous entry location, control an output to signal an occurrence of an anomalous entry event.

An aspect of the invention may comprise a tangible, non-transient computer readable carrier medium carrying a computer program product, the computer program product configured such that, when executed by a system comprising at least one processor, causes the system to monitor a region to detect an intruder entering a region having a boundary that includes one or more unacceptable boundary crossings that constitute some of the boundary, wherein the region is enterable via said one or more unacceptable boundary crossings, the monitoring comprising: receiving a first set of Ranging Active Reflective Wave Detector (RARWD) measurements from an RARWD configured to observe the region; from the first set of RARWD measurements, identifying at least one unacceptable entry detection region; receiving a second set of RARWD measurements to monitor for an intruder into the region; determining from the second set of RARWD measurements a current location of first appearance of a human in RARWD measurements for an entry into the region, the current location comprising a position in space; determining whether a person has entered the region via an anomalous entry location based on a position of the current location of first appearance with respect to the at least one unacceptable entry detection region; and responsive to determining that a person has entered the region via an anomalous entry location, controlling an output to signal an occurrence of an anomalous entry event.

An aspect of the invention may comprise a method of configuring any of the systems described above or below, the system comprising the RARWD that is for making one or both of the first set of RARWD measurements and/or the second set of RARWD measurements, wherein the RARWD has a field of view and the boundary of the region includes an unacceptable boundary crossing, and the method comprises installing the RARWD at a location and orientation to have the unacceptable boundary crossing within the field of view.

The individual features and/or combinations of features defined above in accordance with any aspect of the present invention or below in relation to any specific embodiment of the invention may be utilised, either separately and individually, alone or in combination with any other defined feature, in any other aspect or embodiment of the invention.

For those aspects that refer to systems, the system could be integrated into a single device or multiple devices. In the former instance, the system may be a processor (e.g. a microprocessor or microcontroller, or a RARWD on a chip or a combination thereof) or a device which may be integrated into a single housing. In the latter instance the system may comprise distributed devices optionally in wireless (and/or wired) communication with one another.

Furthermore, the present invention is intended to cover apparatus configured to perform any feature described herein in relation to a method and/or a method of using or producing, using or manufacturing any apparatus feature described herein.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 is a schematic of a system for monitoring a region to detect an intruder;

FIG. 2 is a schematic illustration of an alternative system for monitoring a region to detect an intruder;

FIG. 3 is a schematic illustration of a further system for monitoring a region to detect an intruder;

FIG. 4 is a schematic illustration of a sensing device for monitoring a region;

FIG. 5 is a flowchart illustrating a method for monitoring a region to detect an intruder;

FIG. 6 illustrates a human body with indications of reflections measured by a ranging active reflective wave detector;

FIG. 7 is a plan schematic illustrating an example of operation of a method for monitoring a region to detect an intruder;

FIG. 8 is a plan schematic illustrating another example of operation of a method for monitoring a region to detect an intruder;

FIG. 9 is a plan schematic illustrating a further example of operation of a method for monitoring a region to detect an intruder;

FIG. 10 is a plan schematic illustrating a yet further example of operation of a method for monitoring a region to detect an intruder;

FIG. 11 is a schematic illustrating an example of a location of a current location of first appearance of a human with respect to reference locations of first appearance;

FIG. 12 is a schematic illustrating another example of a location of a current location of first appearance of a human with respect to reference locations of first appearance;

FIG. 13 is a schematic illustrating a further example of a location of a current location of first appearance of a human with respect to reference locations of first appearance;

FIG. 14 is a schematic illustrating a yet further example of a location of a current location of first appearance of a human with respect to reference locations of first appearance;

FIG. 15 is a schematic illustrating another example of a location of a current location of first appearance of a human with respect to reference locations of first appearance;

FIG. 16 is a plan schematic illustrating an example of operation of a method for monitoring a region to detect an intruder;

FIG. 17 is a plan schematic illustrating an object detection delay during operation of a method for monitoring a region to detect an intruder;

FIG. 18 is a plan schematic illustrating a different example of operation of a method for monitoring a region to detect an intruder;

FIG. 19 is a plan schematic illustrating another example of operation of a method for monitoring a region to detect an intruder;

FIG. 20 is a flowchart illustrating an example of a method for monitoring a region to detect an intruder; and

FIG. 21 is a flowchart illustrating an alternative method for monitoring a region to detect an intruder.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals. In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller, or other type of processor.

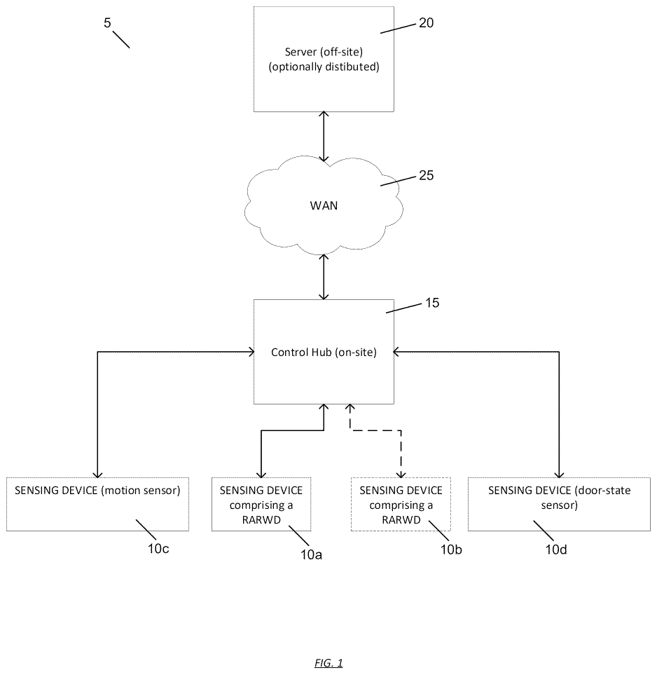

Specific embodiments will now be described with reference to the drawings. FIG. 1 illustrates one example arrangement of a system 5 for monitoring a region to detect an intruder. The system 5 comprises one or more sensing devices 10a, 10b, 10c, 10d, in communication with a control hub 15.

In this example, there are a plurality of sensing devices 10a, 10b, 10c, 10d, including at least one (and optionally a plurality of) ranging active reflective wave detectors (RARWD) 10a, 10b. Each of the RARWDs could be, for example, a detector comprising a RADAR, or LIDAR or similar detector that emits waves, and collects and processes reflections of the waves to determine presence and location of objects. Each RARWD 10a, 10b is capable of determining a range (i.e. a measured distance) and bearing to the object and thus the location of objects in three dimensions. The data generated by each RARWD 10a, 10b is time correlated, e.g. by time stamp, such that it is possible to determine, from the RARWD measurements, the location in three dimensions of each object within the field of view of the RARWD 10a, 10b for any given time.

The sensing devices 10a, 10b, 10c, 10d also include different forms of sensing device other than RARWDs 10a, 10b. For example, the sensing devices could include one or more motion sensors 10c, such as PIR sensors, and one or more door or window state sensors 10d. These are particularly suited to detecting entry into a monitored region but are generally not capable of determining the three-dimensional location of objects.

In this example, the control hub 15 is an on-site control hub (i.e. at the same premises as the sensing devices 10a, 10b, 10c, 10d). The control hub 15 and sensing devices 10a, 10b, 10c, 10d can communicate via wired or wireless communication, and the communications can include, for example, the data generated by each sensing device 10a, 10b, 10c, 10d being communicated to the control hub 15, control commands for controlling or operating the sensing devices 10a, 10b, 10c, 10d and/or the like. The control hub 15 is configured to communicate with a remote server 20 over a WAN or cloud based communication channel 25. There are several possibilities for processing the data generated by the sensing devices 10a, 10b, 10c, 10d in order to monitor the region to detect intruders. For example, the processing could be performed on the sensing devices 10a, 10b that comprise the at least one RARWD 10a, 10b. Additionally, or alternatively, the processing could be performed on the control hub 15 and/or on the remote server 20 or distributed between any or all of the RARWDs 10a, 10b, the control hub 15 and/or the remote server 20, or any combination thereof.

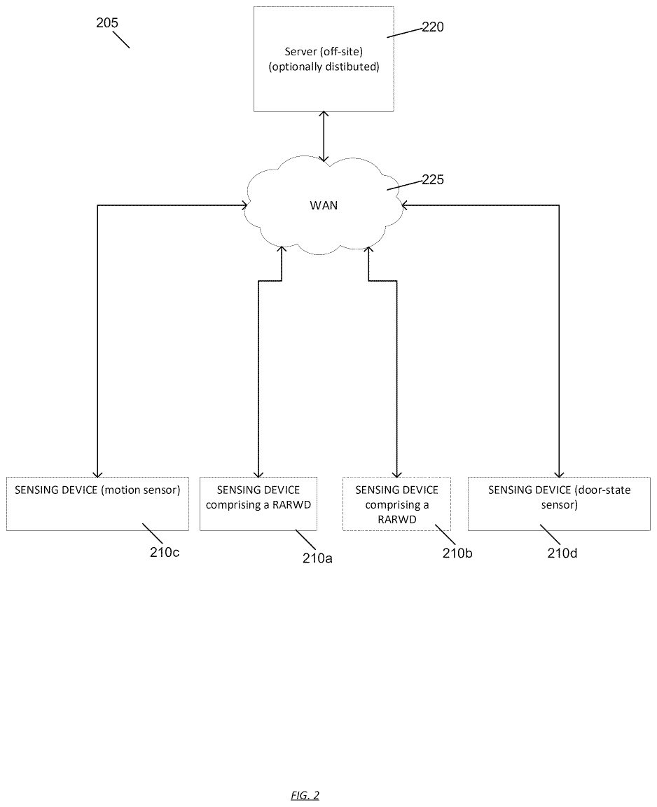

FIG. 2 illustrates an alternative example arrangement of a system 205 for monitoring a region to detect an intruder. The system 205 comprises one or more sensing devices 210a, 210b, 210c, 210d and the remote server 220. Similarly to the arrangement of FIGS. 1, the one or more sensing devices 210a, 210b, 210c, 210d can comprise one or more, e.g. a plurality of, RARWDs 210a, 210b, one or more motion detectors 210c such as PIR detectors and/or one or more door or window opening sensors 210d. However, the system 205 of FIG. 2 differs from that of FIG. 1 in that the sensing devices 210a, 210b, 210c and 210d are configured for internet based communications and thereby to communicate with the remote server 220, optionally over a cellular communications channel, directly over the WAN or cloud based communication channel 25 and there is no local control hub 15. In this example, although all of the processing of the data generated by the one or more sensing devices 210a, 210b, 210c, 210d could be processed entirely on the one or more sensing devices 210a, 210b, 210c, 210d or entirely on the remote server 220, beneficially processing of the data to monitor the region for intruders is distributed between the one or more sensing devices 210a, 210b, 210c, 210d and the remote server 220, which any required data being passed therebetween via the WAN or cloud based communication channel 25.

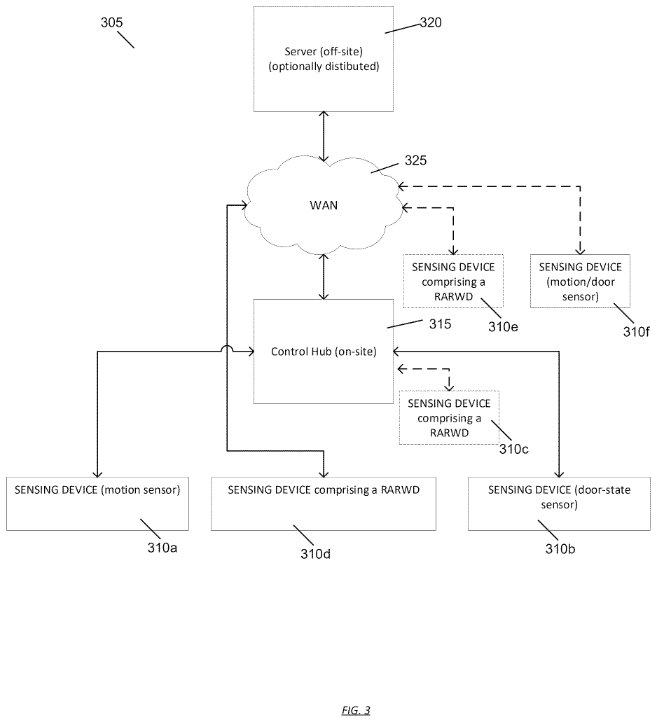

FIG. 3 illustrates a further example arrangement of a system 305 for monitoring a region to detect an intruder. The system 305 of FIG. 3 is, in effect, a hybrid of the systems 5, 205 of FIGS. 1 and 2 in that the system comprises a control hub 315 and a plurality of sensing devices 310a-f, wherein some of the plurality of sensing devices 310a, 310b, 310c communicate with the local control hub 315 and some of the sensing devices 310d, 310e, 310f communicate, optionally over a cellular communications channel, directly with a remote server 320 over the WAN or cloud based communications channel 325 without going through the local control hub 315. The sensing devices 310a-f optionally include different types of sensing device, in this example including a motion sensor 310a, a door or window state sensor 310b and optionally a RARWD 310c that communicate with the local control hub 315 and a plurality of additional or alternative RARWDs 310d, 310e and a further motion or door opening sensor 310f. However, types, numbers and distribution of sensing devices 310a-f is not limited to this and other types, combinations and/or numbers of sensing devices and other distributions of sensing devices between those communicating with a local control hub 315 and those communicating directly with the remote server 320 could be used.

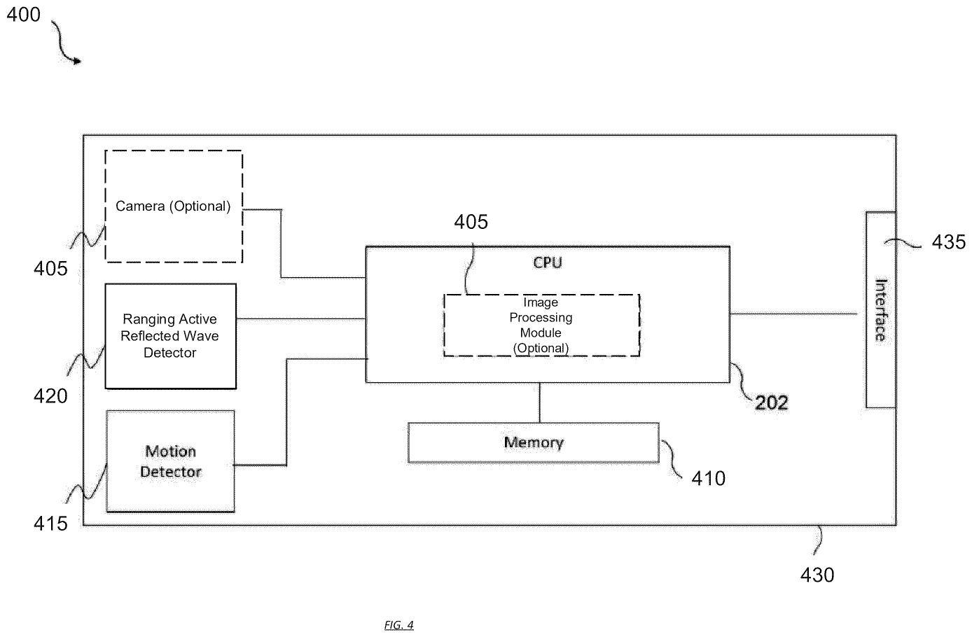

FIG. 4 is a schematic of an example of a sensing device 400 that comprises a RARWD and could optionally be used as any of the sensing devices 10a, 10b, 210a, 210b, 310c, 310d, 310e of any of FIGS. 1 to 3 or as a stand-alone device. In particular, FIG. 4 illustrates a simplified view of the sensing device 400. As shown in FIG. 4, the sensing device 400 comprises a central processing unit (“CPU”) 405, to which is connected a memory 410. The functionality of the CPU 405 described herein could be implemented in code (software) stored on a memory (e.g. memory 410) comprising one or more storage media, and arranged for execution on a processor comprising on or more processing units. The storage media could be integrated into and/or separate from the CPU 405. The code is configured so as to, when fetched from the memory and executed on the processor, perform operations in line with embodiments discussed herein. Alternatively, it is not excluded that some or all of the functionality of the CPU 405 is implemented in dedicated hardware circuitry (e.g. ASIC(s), simple circuits, gates, logic, and/or configurable hardware circuitry like an FPGA). In other embodiments (not shown) a processing system executes the processing steps described herein, wherein the processing system consists of the processor as described herein or could be comprised of distributed processing devices that are distributed across two or more of the devices shown in the system 5, 205, 305 of any of FIG. 1, 2 or 3. Each processing device of the distributed processing devices optionally comprises any one of more of the processing devices or units referred to herein.

FIG. 4 shows the CPU 405 being connected to an optional motion sensor 415, a ranging active reflected wave detector 420, and optionally a camera 425. While in the illustrated embodiment the motion sensor 415, ranging active reflected wave detector 420, and the camera 425 are separate from the CPU 405, in other embodiments, at least part of processing aspects of the motion sensor 415 and/or ranging active reflected wave detector 420 and/or camera 425 could be provided by a processor that also provides the CPU 405, and resources of the processor could be shared to provide the functions of the CPU 405 and the processing aspects motion sensor 415 and/or ranging active reflected wave detector 420 and/or camera 425. Similarly, functions of the CPU 405, such as those described herein, could be performed in the motion sensor 415 and/or the ranging active reflected wave detector 420 and/or the camera 425.

The ranging active reflected wave detector 420 operates to emit electromagnetic waves into the region and to measure wave reflections of those emitted waves that have been reflected by objects in the region.

The sensing device 400 further comprises a communications interface 435 for interfacing with at least one of: a local hub (not shown), other sensing devices 400, and/or directly with a remote server, depending on the particular configuration of the sensing device 400. In this way, data can be transferred, control instructions can be sent and/or received, and/or processing performed locally, remotely or according to any suitable distributed processing scheme. The communications interface 435 can be configured for one or both of: wired and/or wireless communication.

As shown in FIG. 4, a housing 430 of the sensing device 400 houses the motion sensor 415, the ranging active reflected wave detector 420 and the camera 425. Alternatively, the motion sensor 415 could be external to the device 400 and be coupled to the CPU 405 by way of a wired or wireless connection. Similarly, the ranging active reflected wave detector 420 could be external to the device 400 and be coupled to the CPU 405 by way of a wired or wireless connection. Similarly, the camera 425 could be external to the device 400 and be coupled to the CPU 405 by way of a wired or wireless connection. Further, the outputs of the motion sensor 415 and/or ranging active reflected wave detector 420 and/or camera 208 could be wirelessly received from/via an intermediary device that relays, manipulates and/or in part produces their outputs, for example the control hub 15, 315.

In various methods described herein the ranging active reflected wave detector 420 monitors a region and determines a location that a person of first appears in the region, referred to herein a location of first appearance. The location of first appearance may correspond to where a person is first recognisable in measurements by the ranging active reflected wave detector 420 after not being in the region, or in some embodiments after the region had been unoccupied by people. The location of first appearance may correspond to where a person first appears after a detected triggering event signifying that the person has or is about to enter the region. Optionally, the detected triggering event configures the ranging active reflected wave detector 420 to capture measurements and/or configures the CPU or ranging active reflected wave detector 420 to the track objects suspected of being human, based on measurements captured by the ranging active reflected wave detector 420.

In embodiments, the CPU 405 is optionally configured to detect motion in the environment based on an output of the motion sensor 415. In some examples, detection of motion in the environment immediately after a period where no motion has been detected for at least a threshold period of time acts as the detected triggering event associated with entry into a region being monitored. The motion sensor 415 could be a passive infrared (PIR) sensor. The motion sensor 415 is preferably a PIR sensor, however it could be an active reflected wave sensor, for example radar, that detects motion based on the Doppler effect, which may optionally be provided by the ranging active reflected wave detector 420. For example, the motion sensor 415 could be a radar-based motion sensor which detects motion based on the Doppler component of a radar signal. The motion sensor 415 is configured to detect motion in a motion detection monitoring region in the environment. The lateral field of view of the motion sensor 415 could be between 100° and 120°. It will be appreciated that this angle range is merely an example, the lateral field of view of the motion sensor 415 could be up to 160° or higher. The motion detection monitoring region is bound by a minimum detection range of the motion sensor 415 and a maximum detection range of the motion sensor 415. If an object is moving beyond the maximum detection range of the motion sensor 415, the motion sensor 415 will not detect this movement, or at least not as reliably (e.g. the motion sensor 415 won't meet its performance specifications). Similarly, if an object is moving between the motion sensor 415 and the minimum detection range of the motion sensor 415, the motion sensor 415 will not detect this movement, or at least not as reliably.

The ranging active reflected wave detector 420 operates in accordance with one of various reflected wave technologies. In operation, the CPU 405 uses the output of the ranging active reflected wave detector 420 to determine the presence of a target object (e.g. human). The lateral field of view of the ranging active reflected wave detector 420 could have a field of view of 160°, for example.

In these examples, the ranging active reflected wave detector 420 is a ranging detector. That is, in contrast with Doppler-only detectors, the ranging active reflected wave detector 420 is configured to determine the location of any object (e.g. a person) in its field of view in three dimensions. This enables the CPU 405 to track the location of an object in the environment. The ranging active reflected wave detector 420 is also configured to correlate the location of the objects with time, so that the location of the object (e.g. human) can be determined for a given time.

In some implementations, the ranging active reflected wave detector 420 provides both a ranging-based output and a Doppler-based output based on measuring wave reflections from the environment. In these implementations, the ranging active reflected wave detector 420 is configured to detect motion in a motion detection monitoring region in the environment, and a dedicated motion sensor 415 is not required. In some examples, detection of motion by the ranging active reflected wave detector 420 in the environment immediately after a period where no motion has been detected for at least a threshold period of time could act as the detected triggering event associated with entry into a region being monitored. Preferably, the ranging active reflected wave detector 420 is a radar sensor. The radar sensor could use millimeter wave (mmWave) sensing technology. The radar is, in some embodiments, a continuous-wave radar, such as frequency modulated continuous wave (FMCW) technology. Such a chip with such technology may be, for example, Texas Instruments Inc. part number iwr6843 or iwr16432. The radar generally operates in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The ranging active reflected wave detector 420 may comprise antennas for both emitting waves and for receiving reflections of the emitted waves, and in some embodiment different antennas may be used for the emitting compared with the receiving.

The RARWD 420 is also associated with a “RARWD monitoring region”, in the case of the RARWD 420 being a radar, it is more particular associated with a “radar monitoring region”. The monitoring region is the region in the environment that the RARWD 206 observes and monitors, when operational, as limited at least by the radar's field of view and minimum and maximum detection ranges. The monitoring by the ranging active reflected wave detector 420 (e.g. a radar) could be, or include, any one or more of observing, checking, or keeping a continuous record of reflective wave measurements (e.g. radar measurements). Further, there could be different parts of the RARWD monitoring region that are monitored in respectively different ways. For example, it may be that reflective wave measurements (e.g. radar measurements) are performed and tested against a certain condition for one part of the RARWD monitoring region, such as a region of interest, whereas reflective wave measurements (e.g. radar measurements) for another part of the RARWD monitoring region, such as the remaining area outside the region of interest, may merely be performed but then disregarded. The disregarding of such measurements could be because they are outside the region of interest. For example, the monitoring could comprise generating reflective wave measurements (e.g. radar measurements) for all of the radar monitoring region and subsequently reducing the set of measurements to be confined to a smaller area that is under surveillance.

The RARWD monitoring region is limited by the minimum detection range of the ranging active reflected wave detector 420 and a maximum detection range of the ranging active reflected wave detector 420. If an object is present beyond the maximum detection range of the ranging active reflected wave detector 420, the ranging active reflected wave detector 420 will not detect the object. Similarly, if an object is present between the ranging active reflected wave detector 420 and the minimum detection range of the ranging active reflected wave detector 420, the ranging active reflected wave detector 420 will not detect the object.

A user is also able to define one or more “RARWD region of interest” associated with the ranging active reflected wave detector 420. A RARWD region of interest is, or is within, the radar monitoring region and may be defined as a region that causes a certain action to be taken. This action that is performed could be that the object detected in the radar region of interest is tracked. In some examples, the radar region of interest corresponds to a region defined by a virtual fence within the field of view of the ranging active reflected wave detector 420. During installation of the sensing device 400, the installer will switch the sensing device 400 to a calibration or configuration mode for the defining of the virtual fence. Exemplary methods for an installer to define such a virtual fence is described in International patent application number PCT/IL2020/050130, filed 4 Feb. 2020, the contents of which are incorporated herein by reference in their entirety. However, other methods of defining a virtual fence could alternatively be employed. It will be appreciated that more than one virtual fence could be defined within the field of view of the ranging active reflected wave detector 420. The region of interest would generally be defined on a case-by-case basis at installation, depending on the use case, e.g. the environment in which it is installed.

As will be appreciated the ranging active reflected wave detector 420 is an “active” detector in the sense of it relying on delivery of waves from an integrated source in order to receive reflections of the waves. The ranging active reflected wave detector 420 is not limited to being a radar sensor, and in other embodiments alternative ranging detectors could be used, for example the ranging active reflected wave detector 420 could be a LIDAR sensor, or a sonar sensor.

Thus, whilst we refer herein to a “radar region of interest” and a “radar monitoring region” such terms may more generally be substituted with “region of interest of the active reflected wave detector” and “monitoring region of the active reflected wave detector”, respectively.

The ranging active reflected wave detector 420 being a radar sensor is advantageous over other reflected wave technologies in that radar signals can transmit through some materials, e.g. wood or plastic, but not others-notably water which is important because humans are mostly water. This means that the radar can potentially “see” a person in the environment even if they are behind an object of a radar-transmissive material. Depending on the material, this may not be the case for sonar or LIDAR.

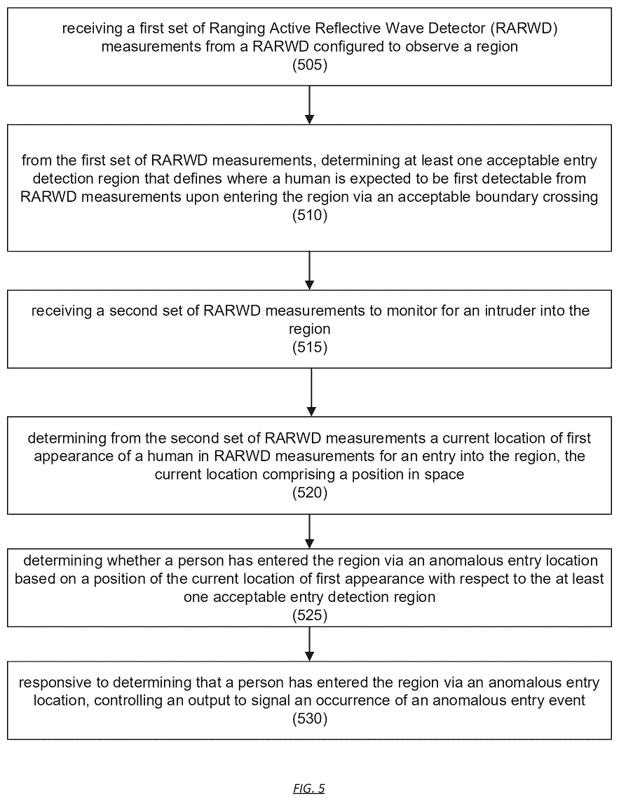

FIG. 5 is a flowchart illustrating a computer-implemented method of monitoring a region to detect an intruder, which could be carried out using the systems 5, 205, 305 of any of FIGS. 1 to 3, and/or which could be carried out using the device 400 of FIG. 4. Given that the method can be performed by any of the systems 5, 205, 305 of FIGS. 1 to 3, or by other systems having different arrangements, performance of the method can be performed by a processor of any, some or all of: one or more or each of the sensing devices 10a-10d, 210a-210d, 310a-310f, the local control hub 15, 315, the remote server 20, 220, 320 or by a different computing resource. That is, the method could be performed entirely on any of the devices or systems listed above, or distributed over some or all of the devices listed above, in which one or more steps of the method given could be performed by a different device to at least one other of the steps, with any data required to perform the step being communicated between devices.

At 505, the method comprises receiving a first set of Ranging Active Reflective Wave Detector (RARWD) measurements for detecting or optionally tracking human position in multiple spatial dimensions within a region observed by at least one RARWD. For example, the first set of RARWD measurements could be collected using the device 400 or the sensing device 10a, 10b, 210a, 210b, 310c, 310d, 310e that comprises the RARWD in the systems 5, 205, 305 of any of FIG. 1, 2 or 3. In some examples, the first set of RARWD measurements are collected during a defined learning period, such as but not limited to a set-up period or a learning period selected by a user or installer or the like.

The first set of RARWD measurements could be, but need not, be collected in a single session. For example, the first set of RARWD measurements could optionally comprise a plurality of subsets of RARWD measurements, wherein each subset of RARWD measurements is for a different period of time. That is, the first set of RARWD measurements could be collected during a single session or single operation of the RARWD sensing device 10a, 10b, 210a, 210b, 310c, 310d, 310e, 400 or could be collected over multiple different sessions or operations of the RARWD sensing device 10a, 10b, 210a, 210b, 310c, 310d, 310e, 400.

Similarly, each of the measurements in the first set or RARWD measurements could be observed by the same RARWD sensing device 10a, 10b, 210a, 210b, 310c, 310d, 310e, 400 or the first set of RARWD measurements may be measurements observed by a plurality of the RARWD sensing devices 10a, 10b, 210a, 210b, 310c, 310d, 310e, 400, i.e. at least one RARWD measurement of the first set of RARWD measurements could be observed by a different RARWD sensing device 10a, 10b, 210a, 210b, 310c, 310d, 310e, 400 to the RARWD sensing device 10a, 10b, 210a, 210b, 310c, 310d, 310e, 400 that observes at least one other of the first set of RARWD measurements.

In examples, the local control hub 15, 315 can send instructions to at least one of the RARWD sensing devices 10a, 10b, 210a, 210b, 310c, 310d, 310e, 400 to emit waves (e.g. electromagnetic waves such as radio waves or microwaves) to measure the first set of RARWD measurements based on the reflections of the emitted waves received by the at least one of the RARWD sensing devices 10a, 10b, 210a, 210b, 310c, 310d, 310e, 400. The measurements are ranging measurements including at least a range to any reflecting objects and a bearing to any reflecting objects, and are time correlated so that a three-dimension position of any reflecting object (such as a human) represented in the first set of RARWD measurements can be determined for a given moment in time.

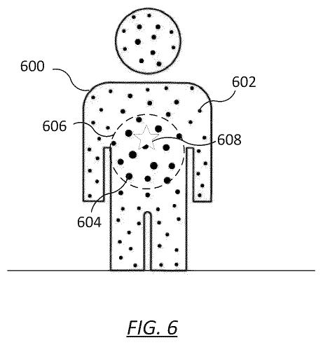

The presence of a human can be identified from the RARWD measurements using any suitable technique, such as identifying a pre-determined profile indicative of a human in the RARWD measurements, identifying a signature change in the RARWD measurements at a point in time, or the like. The location of the human can also be determined from the RARWD measurements using any suitable technique, such as but not limited to that described below in relation to FIG. 6.

At 510, at least one acceptable entry detection region is determined from the first set of RARWD measurements. The acceptable entry detection region defines where a human is expected to be first detectable from RARWD measurements upon entering the observed region (i.e. the region observed by the RARWD) via an acceptable boundary crossing.

In many cases, the region observed by the RARWD sensing devices 10a, 10b, 210a, 210b, 310c, 310d, 310e, 400 corresponds to an entirety or a part of an interior of a building, such as a home or a business premises, for example, wherein the interior can be closable by one or more doors. However, this need not be the case, and the region could be or additionally comprise an exterior region. For example, the observed region could be defined by a virtual or physical fence, or by a field of view and/or range limitation of the RARWD sensing devices 10a, 10b, 210a, 210b, 310c, 310d, 310e, 400 in which the RARWD sensing devices can detect a typical human, amongst other possibilities.

In general, there are only a limited number of acceptable boundary crossings of a boundary of the observed region through which boundary crossings humans can be expected to legitimately access the observed region. These could span a doorway or other entrance/exit, such as an opening to a hallway, an archway, a passage into another area, or the like. However, the acceptable boundary crossings need not be a structural passageway or even a physical barrier. For example, an acceptable boundary crossing could correspond to any part of the boundary of the observed region that opens into space, for example an edge of a field of view, whereby a person could enter the observed region via such a part of the boundary. Furthermore, although a doorway is given as an example of an acceptable boundary crossing, this need not always be the case. For example, a door may be generally not in use, or only generally used at certain times of day. In this case, the doorway could be an unacceptable boundary crossing or only an acceptable boundary crossing at the certain times of day that it is generally used and an unacceptable boundary crossing at other times.

In examples, the at least one acceptable entry detection region can be defined by learning at least one reference location of first appearance of a human for an entry into the region that is represented in the first set of RARWD measurements. For example, each of the at least one reference locations could comprise a position in space. The at least one acceptable entry detection region could comprise, be based on, or in an embodiment is, the at least one reference location of first appearance. For example, the at least one acceptable entry detection region could comprise a cluster or group of reference locations of first appearance of a human for an entry into the region, as represented in the first set of RARWD measurements, e.g. a region with a boundary defined by a threshold distance around each of the reference locations of first appearance in the cluster or group.

In some examples, the at least one acceptable entry detection region can be determined based on one or more entries to the region, represented in the first set of RARWD measurements, that change an occupancy of the monitored region from unoccupied to occupied. In these cases, the process of determining the at least one acceptable entry detection region excludes entries to the monitored region when it is already occupied or for which an immediately prior occupancy status of the monitored region is unknown.

Various exemplary possibilities for determining the at least one acceptable entry detection region are discussed in more detail below with reference to FIGS. 7 to 10.

At 515, a second set of RARWD measurements are received. The second set of RARWD measurements are RARWD measurements taken to monitor for an intruder into the region. The second set of RARWD measurements generally relates to a period of time after the measurement of the first set of RARWD measurements. In some examples, the second set of RARWD measurements are operational measurements taken when the system 5, 205, 305 is in an operational state in which it monitors for an intruder into the region and the first set of RARWD measurements are learning or training measurements collected while the system 5, 205, 305 is in a training or learning state, but the disclosure is not limited to this and other possibilities, e.g. continuous learning or re-using monitoring/detection data for learning, could be envisaged.

Beneficially, the second set of RARWD measurements are collected using the same RARWD sensing devices 10a, 10b, 210a, 210b, 310c, 310d, 310e, 400, used to collect the first set of RARWD measurements. However, possibilities in which different RARWD sensing devices are used to collect the first and second set of RARWD measurements are also envisaged.

At 520, a current location of first appearance of a human for an entry into the region is determined from the second set of RARWD measurements. The current location comprises a point or position in space, i.e. for which a spatial relationship (e.g. a distance) between different locations is determinable. The location could be defined by coordinates.

In some implementations, the locations of first appearance of a human in RARWD measurements for an entry into the region comprise a location in an earliest measurement frame of the second set of RARWD measurements in which the human is detectable for a given instance of the human entering the region. In other implementations, the location of first appearance of a human in the second set of RARWD measurements for an entry into the region comprises a location based on an earliest set of measurement frames in which the human is detectable for a given instance of the human entering the region. The earliest set could comprise a predetermined number of successive measurement frames or however many measurement frames are recorded during a predetermined maximum period of time (e.g. 1 second), for example.

At 525, it is determined whether a person has entered the region via an anomalous entry location based on a position of the current location of first appearance with respect to the at least one acceptable entry detection region.

In this example, determining whether a person has entered the region via an anomalous entry location based on a position of the current location with respect to the at least one acceptable entry detection region comprises determining whether the current location fails to have a requisite spatial proximity relationship with respect to the at least one acceptable entry detection region. For example, the person can be considered to have entered the region via an anomalous entry location if the current location does not overlap with, or is further than a threshold distance from any part of the at least one acceptable entry detection region.

At 530, responsive to determining that a person has entered the region via an anomalous entry location, the method comprises controlling an output to signal an occurrence of an anomalous entry event.

Importantly, an anomalous entry event could, but doesn't necessarily, comprise or result in the raising of an alarm. For example, the anomalous entry could correspond to an unacceptable entry and/or it could simply not correspond to an acceptable entry. As such, responsive to the signaling of the occurrence of the anomalous entry event, an alarm (e.g. an audio, visual and/or haptic alarm) could be raised, and/or a corroborating or other action could be taken, such as operation of a further intruder detection device or process to corroborate the anomalous entry event. This could involve, for example, operating a camera to collect images of the region, or canvassing input from other types of motion or presence sensors, or an audio sensor or the like. The other action could involve recording the event in a log, messaging or alerting a designated recipient such as the user or a monitoring center or the like.

FIG. 6 illustrates a technique for determining a location of a human using at least one of the RARWD sensing devices 10a, 10b, 210a, 210b, 310c, 310d, 310e, 400. However, there are various techniques for determining a location using the RARWD sensing devices 10a, 10b, 210a, 210b, 310c, 310d, 310e, 400, and the present disclosure is not limited to the example of FIG. 6.

FIG. 6 illustrates a free-standing human body 600 with indications of reflective wave reflections therefrom in accordance with some embodiments.

For each reflected wave measurement, for a specific time in a series of time-spaced reflected wave measurements, the reflected wave measurement may include a set of one or more measurement points 602 that make up a “point cloud”, the measurement points 602 representing reflections from respective reflection points from the environment (e.g. from the RARWD sensing devices 10a, 10b, 210a, 210b, 310c, 310d, 310e, 400 observable regions or region of interest). In embodiments, the RARWD sensing devices 10a, 10b, 210a, 210b, 310c, 310d, 310e, 400 provide an output for each captured frame as a point cloud for that frame. Each point 302 in the point cloud may be defined by a 3-dimensional spatial position from which a reflection was received, and defining a peak reflection value, and a Doppler value from that spatial position. Thus, a measurement received from a reflective object may be defined by a single point, or a cluster of points 602 from different positions on the object (e.g. the human 600, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the RARWD sensing devices 10a, 10b, 210a, 210b, 310c, 310d, 310e, 400 using moving target indication (MTI). Thus, in these embodiments there must be a moving object in order for there to be reflected wave measurements from the RARWD sensing devices 10a, 10b, 210a, 210b, 310c, 310d, 310e, 400 (i.e. measured wave reflection data), other than noise. Alternatively, a point cloud can be received from the RARWD sensing devices 10a, 10b, 210a, 210b, 310c, 310d, 310e, 400 for each frame, where the point cloud has not had pre-filtering out of reflections from moving points. Preferably for such embodiments, the received point cloud can be filtered to remove points having Doppler frequencies below a threshold to thereby obtain a point cloud representing reflections only from moving reflection points. In both of these implementations, the measured wave reflection data that corresponds to point clouds can be accrued for each frame whereby each point cloud represents reflections only from moving reflection points in the environment.

In some embodiments, measured wave reflection data may comprise signals received from an array of transducers (e.g. antennas) and/or may be represented by analog or digital signals that precede a digital signal processing (dsp) component of the apparatus. For example, even in embodiments that generate a point cloud, the measured wave reflection data may be data that precedes calculation of the point cloud by the dsp component.

In other embodiments, no moving target indication (or any filtering) is used. In these implementations, the measured wave reflection data which corresponds to point clouds is accrued for each frame whereby each point cloud can represent reflections from both static and moving reflection points in the environment.

FIG. 6 illustrates a map of reflections. The size of the point represents the intensity (magnitude) of energy level of the radar reflections (see larger point 604). Different parts or portions of the body reflect the emitted signal (e.g. radar) differently. For example, generally, reflections from areas of the torso 606 are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points 602, 604 are received from an object in the environment, a location of a particular part/point on the object or a portion of the object, e.g. its centre, may be determined from the cluster of measurement point positions having regard to the intensity or magnitude of the reflections (e.g. a centre location comprising an average of the locations of the reflections weighted by their intensity or magnitude). As illustrated in FIG. 6, the reference body 600 has a point cloud from which its centre has been calculated and represented by the location 608, represented by the star shape. In this embodiment, the torso 606 of the body 600 is separately identified from the body 600 and the centre of that portion of the body is indicated. In alternative embodiments, the body 600 can be treated as a whole or a centre can be determined for each of more than one body part e.g. the torso 606 and the head, for separate comparisons with centres of corresponding portions of a scanned body 600.

In one or more embodiments, the object's centre 608 or portion's centre is in some embodiments a weighted centre of the measurement points. The locations may be weighted according to a Radar Cross Section (RCS) estimate of each measurement point, where for each measurement point the RCS estimate may be calculated as a constant (which may be determined empirically for the RARWD sensing device 10a, 10b, 210a, 210b, 310c, 310d, 310e, 400) multiplied by the signal to noise ratio for the measurement divided by R⁴, where R is the distance from the RARWD sensing device 10a, 10b, 210a, 210b, 310c, 310d, 310e, 400 antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$W C = \frac{1}{{\sum }_{n = 1}^{N} {W}_{n}} {\sum }_{n = 1}^{N} ( {W}_{n} {P}_{n} )$$

Where:
N is the number of measurement points for the object;
Wₙ is the RCS estimate for the n^{th} measurement point; and
Pₙ is the location (e.g. its coordinate) for the n^{th} measurement point in that dimension.

The region monitored by the RARWD sensing devices 10a, 10b, 210a, 210b, 310c, 310d, 310e, 400 may comprise an entire observable region from which the RARWD sensing devices 10a, 10b, 210a, 210b, 310c, 310d, 310e, 400 are configured to detect reflected waves, which may comprise an interior space within a physical structure (such as a building or a part of a building), the physical structure being closable by having one or more physical barriers not intended to be passed through by a human. The entire observable region may also comprise one or more external regions to the physical structure that are at least sometimes visible to the RARWD sensing devices 10a, 10b, 210a, 210b, 310c, 310d, 310e, 400, e.g. due to opening and closing of doors, moving of screens, or the like.

FIG. 7 shows a plan projection of an exemplary region 700 that is monitored by a RARWD 705, which could be any of the RARWD sensing devices 10a, 10b, 210a, 210b, 310c, 310d, 310e, 400 described above, and could be comprised in any of the systems 5, 205, 305 of any of FIGS. 1 to 3, but the present disclosure is not limited to this. The region 700 is, in this example, a space within a room 707 of a building. The region 700 has a boundary 701 that comprises one or more acceptable boundary crossings 710, 715, 720, 725, 730 (e.g. due to one or more doors) and one or more unacceptable boundary crossings 735 (e.g. due to one or more windows), each of the boundary crossings being indicated by dotted lines in FIG. 7.

In this exemplary environment the boundary 701 to the monitored region 700 also has uncrossable boundary portions due to impenetrable walls 702, 735, which the RARWD 705 is incapable of seeing up to, but not through (i.e. the walls 702, 735 are opaque to radiation emitted by the RARWD 705, such that regions on a far side of the walls 702, 735 are obscured from being visible to the RARWD 705). The room also has additional impenetrable walls 703 and 704, that are not visible to the RARWD 705, and which are indicated by thinner solid lines than for the walls 702, 735 that can be seen by the RARWD 705. The wall 735 projects into the room 707 such that a region 708 on a far side of the wall 735 is obscured from being visible to the RARWD 705.

In FIG. 7, acceptable boundary crossing 710 corresponds to (e.g. be located across) a doorway, such as an external doorway. Acceptable boundary crossings 720, 725 correspond to additional doorways, such as internal doorways, through which access is permitted. Boundary crossing 730 corresponds to an edge of the region 708 obscured from being visible to the RARWD 705 by the protruding wall 735. Since there is an external wall 704 that prevents any access to the obscured region 708 except via the monitored region 700, a person entering the monitoring region 700 from the obscured region 708 is merely re-entering the region 700 and so the boundary crossing 730 can be considered to be an acceptable boundary crossing.

The room 707 also has an illegitimate access point, in the form of a window, through which it is possible to illegitimately enter the region 700. Thus, the boundary 701 to the monitored region 700 has a boundary crossing 740 that spans the window.

Boundary crossing 715 of the monitoring region 700 corresponds to the boundaries of the field of view of the RARWD 705 via which a person could enter the region 700, which in this case is directly below and/or behind the RARWD 705. In this example, the RARWD 705 is located in the corner of a room and the field of view is such that a person could enter the region 700 via the boundary crossing 715. As such the boundary crossing 715 is an edge of a “blind spot” 716 in the room. Depending on how a person may enter the blind spot 706 from beyond the monitoring region 700, the boundary crossing 715 could be an acceptable boundary crossing or a boundary crossing of uncertain acceptability. In presently described example, there are no windows or other illegitimate access points beyond the field of view of the RARWD 705 via which a person could enter the blind spot.

Based on this, the boundary crossing 715 may be treated as an acceptable boundary crossing. In this example, the only way into the blind spot 716 is from the monitoring region, so if a person enters the region 700 from the blind spot 716 that entry can be assumed to be legitimate because the person was already in the room. Further, had a useable door existed in one of the walls 703 behind the field of view of the RARWD 705, then a person's entry from the beyond the monitored region 700 into the blind spot and ultimate into the monitored region 700 would also have been legitimate.

On the other hand, had an illegitimate access point, such as a window, existed in one of the walls 703, then it may be indeterminable whether the person had been in the blind spot because they had legitimately entered it from the region 700 or illegitimately entered it from the illegitimate access point. Thus, the boundary crossing 715 would have uncertain acceptability. For this reason, the boundaries of monitored regions described in embodiments herein may advantageously have no boundary crossings of uncertain acceptability.

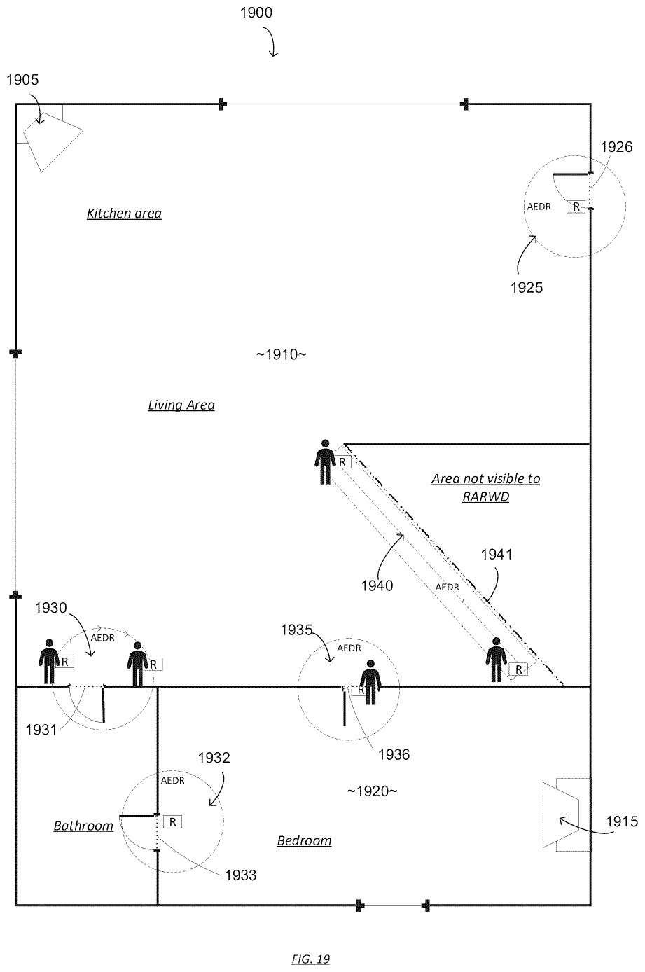

FIG. 18 shows another example of monitoring a region to detect intrusion into the region. FIG. 18 shows a plan view of a premises 1800 comprising a first RARWD 1805 for monitoring a first region 1810 within a first room 1811 (in this example, a living room) and a second RARWD 1815 for monitoring a second region 1820 within a second room 1821 (in this example, a bedroom). Each RARWD 1805, 1810 may be the device 400 or the sensing device 10a, 10b, 210a, 210b, 310c, 310d, 310e that comprises the RARWD in the systems 5, 205, 305 of any of FIG. 1, 2 or 3.

The region 1810 and the first room 1811 of FIG. 18 have the same features as region 700 and the room 707, respectively, of FIG. 7, except the room 1811 has an additional illegitimate access point in the form of a further window 1812. Therefore, the boundary 1813 of the monitoring region 1810 is the same as the boundary 701 of the monitoring region 700, except that the boundary 1813 of the monitoring region 1810 additionally comprises a further unacceptable boundary crossing at the window 1812.

The second room 1821 has an additional RARWD 1815 that has a field of view that includes visibility of another window 1814 and therefore the boundary of the second monitoring region 1820 has an unacceptable boundary crossing at the window. The second room 1821 has a doorway 1819 to the first room 1811. The doorway 1819 provides an acceptable boundary crossing from the first room 1811 to the second room 1821 (and vice versa) because arrival at the doorway 1819 from the first room 1811 can be assumed to legitimate since, as will be described, the RARWD 1805 can be used to catch all illegitimate entries into the first room 1811. Similarly, arrival at the doorway 1819 from the second room 1821 can be assumed to legitimate as the RARWD 1815 can be used to catch all illegitimate entries into the second room 1821. The premises also has a third room (e.g. a bathroom) 1817 that has a doorway 1816 to the second room 1821 and a doorway 1818 to the first room 1811. The doorways 1816 and 1818 provide acceptable boundary crossings for similar reasons to door 1819.

In the example of FIG. 18, in order to monitor the premises 1800, unacceptable entry detection regions 1825, 1830, 1835, 1840 and 1845 (UEDRs) are determined. This involves defining the unacceptable entry detection regions 1825, 1830, 1835, 1840 and 1845 at the unacceptable boundary crossings 1824, 1812, 1814 located, in this example, at illegitimate access points in the form of respective windows. The unacceptable entry detection regions 1825, 1830, 1835, 1840 and 1845 identify where a person may first be detected if they were to pass through at least one of the unacceptable boundary crossings 1824, 1812, 1814.

However, in some examples, the unacceptable boundary crossings 1824, 1812, 1814 and therefore the unacceptable entry detection regions 1825, 1830, 1835, 1840 and 1845 need not exactly correspond to the location of the corresponding illegitimate access points.

For example, one or more external regions may be visible to the RARWDs 1805, 1815 at any location at which one of the one or more physical barriers of the illegitimate access points is at least partially transparent to waves emitted by the RARWD 1805, 1815 such that an object of interest (e.g. a person) beyond the barrier might be detectable by the RARWD (depending on how far the object is beyond the barrier and how transparent the barrier is). With respect to the example of FIG. 18, the RARWD 1815 might be able to see to an extent through the relevant window, such that people immediately outside the window could potentially be detected.

To mitigate against this, if any illegitimate access points are mapped, a respective unacceptable entry detection region may be defined as corresponding to the location of the illegitimate access point and extending more distantly from it with respect to the RARWD. Optionally the extension may be limited as being up to a predefined distance behind the mapped location of the illegitimate access point with respect to the RARWD. During installation, the RARWD 1805, 1815 that has the illegitimate access point within its field of view may determine the shape, size and location of each of the unacceptable entry detection regions from a first set of RARWD measurements.

However, if such detections of people outside the window arise, the unacceptable entry detection region 1845 could extend to the region just outside the window. In this case, the boundary of the region being monitored may (if no virtual fence is set up) have one or more of its boundary crossings 1824, 1812, 1814 beyond rather than at the one or more physical barriers. This situation can be avoided by setting up a virtual fence along a perimeter where said barrier that is at least partially transparent to waves emitted by the RARWD 1815 (i.e. the window 1814 in this example) is located, and optionally along the entire perimeter of the interior space, to ensure that the monitored regions 1810, 1820 are confined to within the interior space to be monitored.

In some examples, determining the at least one unacceptable boundary crossing comprises identifying an object having a predefined character, e.g. based on known measurement parameters associated with the object, such as a radar cross section, kinematic behavior (e.g. moving in a certain way), intensity of a measured signal represented in the RARWD measurements, doppler value, etc.). That is, a distinctive object can be used to indicate and/or mark out the unacceptable boundary crossings in the premises 1800. The indicating and/or marking out is identifiable in the first set of RARWD measurements to enable an unacceptable entry detection region to be defined. The object could simply be a human, e.g. an installer. In other examples, the object could be a reflective device for the RARWD, e.g. a retroreflector (marked R in the Figures).

At least one unacceptable entry detection region can be determined by determining a location of the object and determining an unacceptable entry detection region as comprising a region or margin surrounding and/or adjacent the object, e.g. adjacent the object on a nearest side to the RARWD.

The object can be used to signal the position and one or more dimensions (e.g. width and optionally other dimensions) of the unacceptable boundary crossings. Based on this the unacceptable entry detection region 1825, 1830, 1835, 1840 and 1845 can be defined to comprise a buffer zone or margin, for example, to account for an expected maximum lag between a person crossing the unacceptable boundary crossing and a person being detectable in the second set of RARWD measurements.

In one example, one or more reflective devices are placed on or at each window 1812, 1814, 1824. The RARWD 1805 has a field of view that includes the reflective devices at the windows 1812, 1814 of the first room 1811, and is programmed to detect their locations and attribute unacceptable entry detection regions based on those detections. Each unacceptable entry detection region may optionally be determined to have of a predefined shape and size, about the relevant reflective device. In this example, a cylindrical unacceptable entry detection region of a predefined radius, and having a vertical length axis, is defined about each reflective device. In order to monitor entry via any part of the window 1812, a plurality of reflective devices are places at the window 1812. Enough reflective devices (in this illustration three reflection device) are placed so that enough unacceptable entry detection regions 1830, 1835, 1840 are defined to run alongside, and collectively include an entirety of the window. The reflective devices are spaced from each other by no more distance than double the radius of each unacceptable entry detection regions 1830, 1835, 1840 so that the unacceptable entry detection regions 1830, 1835, 1840 are overlapping or at least touching.

In another example a person 1850c holds a reflective device having a recognisable reflection characteristic and/or makes a recognisable movement to signal to the RARWD 1815 in the second room 1821 that they are at the window 1814. Using RARWD measurements from the RARWD 1815, a location is determined corresponding to the person and/or the reflective device. An unacceptable entry detection region 1845 is defined at that location, for example like performed in relation to the reflective devices at the window 1812.

Optionally, the object can be tracked by the RARWD such that its movement, i.e. position over a period of time, is determinable from the first set of RARWD measurements. In this case, the unacceptable entry detection regions are determined based on the traversed path of the object represented in the first set of RARWD measurements.

For example, a person, optionally carrying a reflective device, may walk from position 1850a at one end of the window 1824 to position 1850b at the opposite end of the window 1824 to map the length of the unacceptable boundary crossing that exists at that window 1824. The person's location is tracked using a first set of RARWD measurements from RARWD 1805 to determine a travel path of the person, and an unacceptable entry detection region 1825 is defined about the travel path.

Once the first set of RARWD measurements is collected the object is removed from the premises.

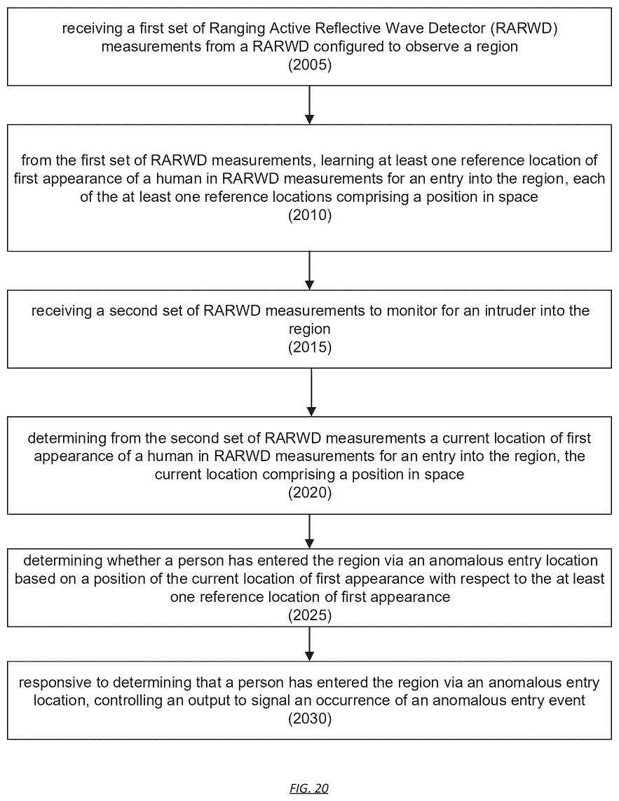

FIG. 19 shows another example of monitoring a region to detect intrusion into the region. FIG. 19 shows a plan view of a premises 1900 that is identical to premises 1800 of FIG. 18. In FIG. 19, the monitoring of a region to detect intrusion could be performed by a first RARWD 1905 for monitoring a first region 1910 and a second RARWD 1915 for monitoring a second region 1920. Each RARWD 1905, 1910 may be the device 400 or the sensing device 10a, 10b, 210a, 210b, 310c, 310d, 310e that comprises the RARWD in the systems 5, 205, 305 of any of FIG. 1, 2 or 3.

In this example, acceptable entry detection regions are determined from a first set of RARWD measurements. The acceptable entry detection regions (AEDRs) 1925, 1930, 1932, 1935 and 1940 are mapped to identify respective regions where a person may be first detected upon entering the premises 1800 if they enter either of the monitored regions 1910, 1920 of the premises at a location (e.g. at a door, passage or other opening to a monitored region 1910, 1920) that implies a legitimate entry, and it is therefore an acceptable boundary crossing into the region 1910, 1920. For the monitored regions 1910, 1920, there are a plurality of acceptable boundary crossings, namely a boundary crossing 1926 provided so as to cover an external doorway, boundary crossings 1931, 1933, 1936 covering internal doorways and a boundary crossing along a boundary 1941 of an area occluded from the RARWD 1905 by a projecting wall 1950 that is opaque to radiation from the RARWD.

The acceptable entry detection regions (AEDRs) 1925, 1930, 1932, 1935 and 1940 may be mapped using any of the methods used for mapping the unacceptable entry detection regions 1825, 1830, 1835, 1840 and 1845, as described in relation to FIG. 18. In particular, any of the techniques described above to determine unacceptable entry detection regions 1825, 1830, 1835, 1840 and 1845 at unacceptable boundary crossings 1812, 1814, 1824 may be used to determine acceptable entry detection regions 1925, 1930, 1932, 1935 and 1940 at acceptable boundary crossings 1926, 1931, 1933, 1936, 1941.

During operation, after the learning, the RARWDs 1905, 1910 are operable to collect second sets of RARWD measurements to monitor for intrusion into the regions 1910, 1920. The second sets of RARWD measurements are analysed to determine current locations of first appearances of human entry into one of the regions 1910, 1920, wherein the current location comprises a position in space, i.e. a point rather than a nebulous area like a room. The current locations of first appearance are compared to the acceptable entry detection regions 1925, 1930, 1935, 1940, 1945 and if the location of any first location of appearance in the region 1910, 1920 is not within any of the acceptable entry detection regions 1925, 1930, 1935, 1940, 1945 for that region 1910, 1920, then it is determined that the location of first entry is an anomalous entry and an occurrence of an anomalous entry event is signalled.

In some examples, the positions in space a human first appears in RARWD measurements (and therefore the current locations of first appearance for non-anomalous entry) could vary depending on whether a door is open or closed. If a door is already open, then the human may be detected before they reach the doorway. In other words, the acceptable boundary crossing may lie beyond the doorway. In such cases, if this is represented in the first set of RARWD measurements, then the acceptable entry detection region may optionally be defined as extending from the mapped access point to beyond the interior space (optionally to a predefined limit), based on what RARAWD can see when the door is open. In an alternative approach, a virtual fence may be defined where the relevant access point is located, and optionally along the entire perimeter of the interior space to ensure that the monitored regions 1910, 1920 are confined to within the interior space to be monitored.

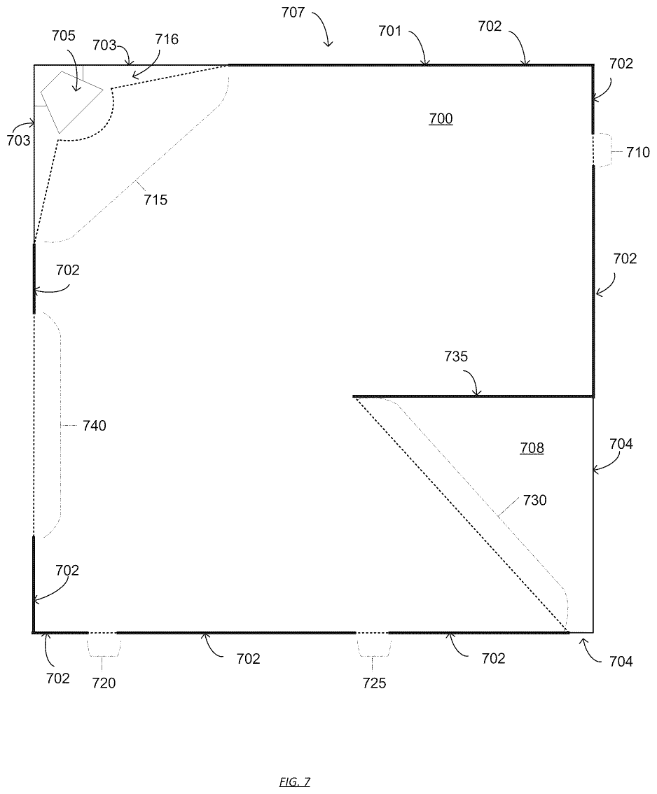

FIG. 8 illustrates a plan projection of an alternative exemplary region 800 that is monitored by a RARWD 805, which could be any of the RARWD sensing devices 10a, 10b, 210a, 210b, 310c, 310d, 310e, 400 described above, and could be comprised in any of the systems 5, 205, 305 of any of FIGS. 1 to 3, but the present disclosure is not limited to this.

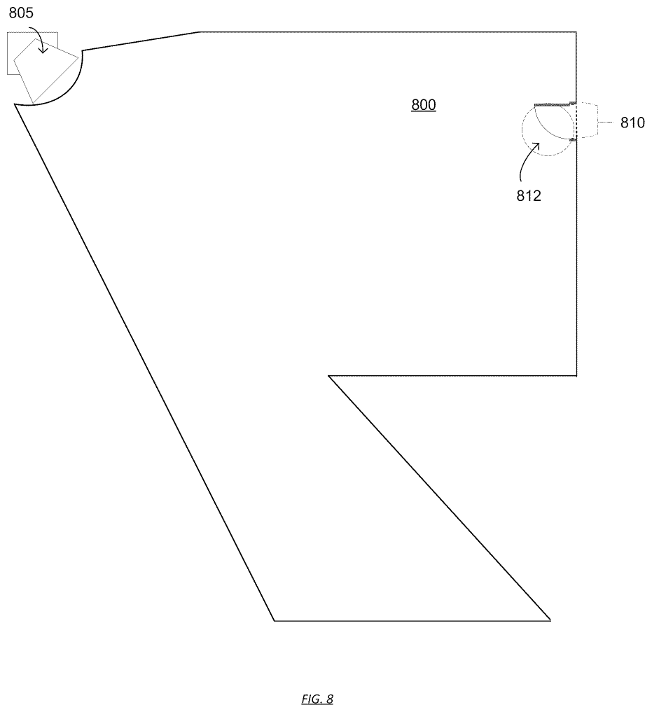

The arrangement of the RARWD 805 in FIG. 8 is such that field of view of the RARWD 805 results in the region 800 comprising one or more acceptable boundary crossings 810 but not any unacceptable boundary crossings. The acceptable boundary crossing 810 could comprise an external doorway, for example, that allows access into the premises in which the region 800 is located. An acceptable entry detection region 812 is defined at the acceptable entry boundary crossing 810. In this case, the system 5, 205, 305 can be configured to keep a record of whether the premises at which the region located is occupied or unoccupied. The occupancy may be considered as context data. In this case, if the first entry of a person into the observed region 800 is also a first entry of a person into the premises after a period of the premises being vacant, anomalous entry into the premises can be detected because the first entry into the observed region 800 cannot be from another part of the premises. So, if an entry is not from the acceptable entry detection region 812, it can be treated as an anomalous entry into the premises. FIG. 9 illustrates a plan projection of an alternative exemplary region 900 that is monitored by a RARWD 905, which could be any of the RARWD sensing devices 10a, 10b, 210a, 210b, 310c, 310d, 310e, 400 described above, and could be comprised in any of the systems 5, 205, 305 of any of FIGS. 1 to 3, but the present disclosure is not limited to this.

The arrangement of the RARWD 905 in FIG. 9 is such that the region 900 comprises at least one unacceptable boundary crossing 910 but no defined acceptable boundary crossings. An unacceptable entry detection region 912 is defined at the unacceptable boundary crossing 910. With this arrangement, any detected first entry into the region other than in the unacceptable entry detection region 912 can be considered as an entry via an acceptable boundary crossing. In this case, there is no need to keep a record of the occupancy of the premises (although this could be done) and entries into the region 900 could include entries for other parts of the premises. However, in this example, the system 5, 205, 305 is able to determine an anomalous entry into the premises based on a first entry of a person into the region 900 that is at the unacceptable entry detection region 912. However, ideally all unacceptable entry boundary crossings 910 (though only one exists in FIG. 9) would be monitored by the RARWD 905 or another device (another RAWRD or otherwise).

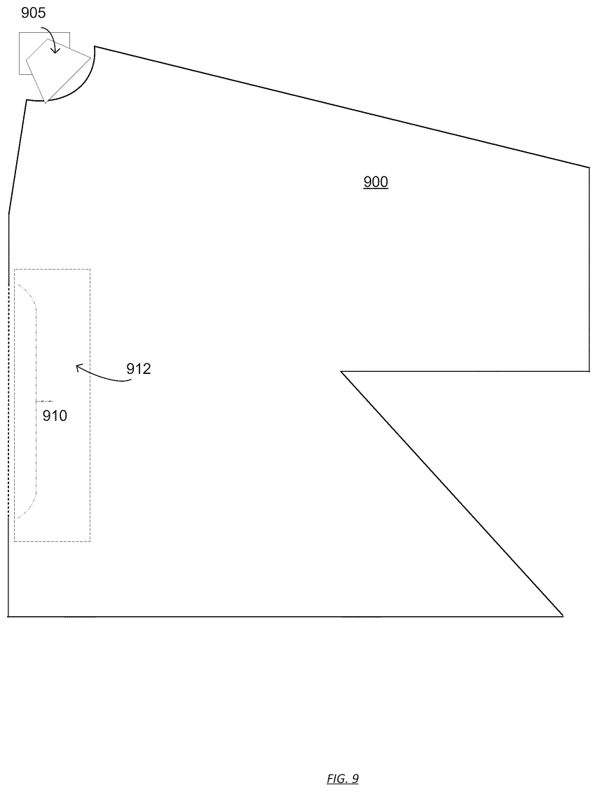

FIG. 10 illustrates a plan projection of a premises 1000 comprising a plurality of regions 1000a, 100b monitored by a plurality of RARWDs 1005, 1010, each of which could be any of the RARWD sensing devices 10a, 10b, 210a, 210b, 310c, 310d, 310e, 400 described above, and could be comprised in any of the systems 5, 205, 305 of any of FIGS. 1 to 3, but the present disclosure is not limited to this.

Each region 1000a, 1000b being monitored generally corresponds to a respective room 1015, 1020 of the premises 1000, in this case a living room 1015 and a bedroom 1020. The living room 1015 is monitored by RARWD 1005, whilst the bedroom 1020 is monitored by different RARWD 1010.

In this example, the system 5, 205, 305 may be configured to use context data such as occupancy immediately prior art detection of a first entry into a region and/or time of day as part of the determination of whether or not to control the output to signal an occurrence of an anomalous entry event. This allows the system 5, 205, 305 to operate accurately with fewer unacceptable boundary crossings.

The first region 1000a is monitored by RARWD 1005 and has a boundary that comprises a plurality (in this case four) acceptable boundary crossings 1025, 1030, 1035 and 1040. Acceptable boundary crossing 1025 corresponds to an external doorway of the premises 1000, acceptable boundary crossing 1030 corresponds to a boundary of an obscured region 1016 that is obscured from the RARWD 1005 by a wall or other barrier that is opaque to radiation emitted by the RARWD 1005, and acceptable boundary crossings 1035, 1040 correspond to internal doorways within the premises 1000. The living room 1015 comprises a window 1045 and therefore an unacceptable boundary crossing may be said to be there. However, there is no defining or monitoring of unacceptable entry detection regions based on a location of an unacceptable boundary crossing of the boundary of the region 1000a.

In the example of FIG. 10, acceptable entry detection regions 1026, 1031, 1036, 1041 and 1046 at the respective acceptable boundary crossings 1025, 1030, 1035, 1040 and 1044 may be defined and employed. However, in contrast with the examples in FIGS. 18 and 19, the acceptable entry detection regions 1026, 1031, 1036, 1041 and 1046 are not defined in a dedicated installation step by an installer nor by involving reflection devices as described above in relation to FIG. 19. Rather, each acceptable entry detection region 1026, 1031, 1036, 1041 and 1046 is learned based on in-use behaviour.

A first set of RARWD measurements from RARWD 1005 is used to learn what positions in space a human first appears in RARWD measurements for respective entry events into the region 1015. Each position of first appearance defines a reference location of first appearance (RLFA). At least one acceptable entry detection region 1026, 1031, 1036, 1041, may then be defined to include within it one or more RLFAs, with all of the RLFAs being mapped to at least one corresponding acceptable entry detection region 1026, 1031, 1036, 1041.

The location of first appearance of a person may in some embodiments be where an actual person is detected. In other examples it may be where an event is detected as occurring where the event is caused by a person, e.g. an opening of a door. For example, a movement of a door may be detected from RARWD measurements, and this may be assumed to be a first appearance of a human. In other embodiments a determination of a first appearance of a person may require an identification, from RARWD measurements, of an object that appears to be human (optionally more specifically adult and/or adolescent humans, for example humans that are at least 10 years old), e.g. based on any known method in the art, which may optionally include an estimated RCS of the object being within a range corresponding to humans, etc. In embodiments in which an RCS estimate, the range may be based on published data or empirically determined. In an example, taking a 77 GHz radar signal as an example, from empirical measurements, the RCS (which is frequency dependent) for human may be taken to be in a range between 0.1 and 1.5 m2, which allows for different potential orientations of a person. The RCS of human in the 57-64 GHz spectrum is similar to the 77 GHz RCS, so similarly a range of 0.1 and 1.5 m2 may be used in an example. If the RCS estimate is outside that range, it may be concluded that the object is inhuman. In other words, determining from the RARWD measurements that the object is human may in some embodiments be as basic as excluding objects having an RCS range indicative of inhuman objects. Optionally a size of the object may additionally or alternatively also be taken into account to determine whether the object is human.

Thereafter the system then uses further, current RARWD measurements to identify an anomalous entry based on a position of a current location of first appearance with respect to the one or more RLFAs. For example, if a current location is too distant from any of the RLFAs, treated individually and/or collectively, it may be determined that the entry is anomalous. Optionally, for ease of calculation, at least one acceptable entry detection region 1026, 1031, 1036, 1041 may be calculated once from the RLFA(s), after a learning period, and thereafter the anomalous entry may be determined to occur in response to determining that the current location is outside all of the at least one acceptable entry detection regions 1026, 1031, 1036, 1041 or expressed another way, inside an unacceptable entry detection region (not shown) comprising every spatial location within the monitored region 1015, except for where there is an acceptable entry detection region 1026, 1031, 1036, 1041.

In any case, an output may then be controlled to signal an occurrence of an anomalous entry event.

Similarly, the second region 1000b is monitored by RARWD 1010 and comprises a boundary having an acceptable boundary crossing 1040, in this example covering an internal doorway and shared with the first region 1000a, and an acceptable boundary crossing 1044 at the doorway to the bathroom. The second region 1000b also has an unacceptable boundary crossing 1045, corresponding with an internal doorway. Acceptable entry detection regions 1041 and 1046 may be determined based on the same learning process as described above in relation to acceptable entry detection regions 1026, 1031, 1036 and 1041. It will be appreciated that the acceptable entry detection location 1041 might be defined differently with respect to entry into the region 1015 compared with region 1020. However, for the sake of simplicity only a single acceptable entry detection location 1041 at the acceptable boundary crossing 1040 is shown.

As indicated, the RLFAs and thereafter acceptable entry detection regions 1026, 1031, 1036, 1041, 1046 may be determined using a first set of Ranging Active Reflective Wave Detector (RARWD) measurements collected by the RARWDs 1005 and 1010, e.g. during a learning or training phase. Any calculated acceptable entry detection location 1026, 1031, 1036, 1041, 1046 may thereby be used to define where a human is expected to be first detectable from RARWD measurements upon entering the regions 1000a, 1000b.

Thereafter, a second set of RARWD measurements is collected using the RARWDs 1005 and 1010 to monitor for intrusion into the regions 1000a, 1000b. In some embodiments the second set comprises the combination of RARWD from multiple RARWDs 1005 and 1010, while in other embodiments each RARWD 1005 and 1010 may be considered separately, each generating its own second set of RARWD measurements, processed independently of one another. In any case, the second set of RARWD measurements is processed to identify a current location of first appearance of a person in the second set of RARWD measurements for an entry into any of the regions 1000a, 1000b. The current location comprises a location in space of the person's first appearance. The system may determine if the person has entered one of the regions 1000a, 1000b at a location that signifies passage through an unacceptable boundary crossing 1025, 1030, 1035, 1040, 1044 by determining if the current location has a required correlation with any of the RLFAs, e.g. if it is comprised in, or is within a threshold distance of any of the RLFAs. If the current location does not have the required correlation with any of the RLFAs, then the system controls an output to signal an anomalous entry event.

Beneficially, context data can be used to improve the monitoring of the regions 1000a, 1000b. The context data can include, for example, occupancy data and/or time context data. For example, the context data can be used to assess a current location of first appearance with respect to one or more RLFAs for the same or similar circumstances. For example, it may be that at certain times of day a first door at boundary crossing 1025 is normally used to enter the premises 1000, so it could be expected that whenever a person first appears in the monitored region 1015 it will be within a region at or near the first door, in particular within the entry detection region 1026. However, it may be that at a different time of day a second door, e.g. at boundary crossing 1040, is always or almost always used, such that if a person first appears in the entry detection region 1026 instead of the entry detection region 1041 at second door at that different time, this may be considered an anomalous entry. Further it may be that which door is usually used depends on whether other people are home, which may be determined from one or more of: the set second RARWD measurements, a set of measurements preceding the second set of RARWD measurements; and/or other occupancy detection devices or systems.

In other examples, the context may be based on other sensed data preceding the first appearance of the person within the monitored region 1015, 1020. For example, rather than or in addition to, a pattern of first entry occurring at a certain time of day and/or occupancy level, pattern of first entry may depend on detection by other sensed devices within a particular time window relative to a time of the first entry.

Any suitable techniques for determining whether a current location of first appearance has a requisite correlation with one or more RLFAs could be used to determine whether a person has entered from a non-anomalous location of entry into the monitored region 1015, 1020. Some examples of suitable techniques may be understood with reference to FIGS. 11 to 15.

The first set of RARWD measurements can contain multiple detections of first appearances of humans for an entry into the regions 1000a, 1000b over a period of time, such as over a learning or training period. Increasing the duration of the learning or training period potentially increases the number of detections of first appearances humans for an entry into the regions 1000a, 1000b. The first sets of RARWD measurements can be suitably collected so that any entry into the regions 1000a, 1000b over the period of time is legitimate (or an assumption made to that effect). Each detection of first appearances of humans entering into the regions 1000a, 1000b represented in the first sets of RARWD measurements over the period of time is treated as a reference location RLFA.

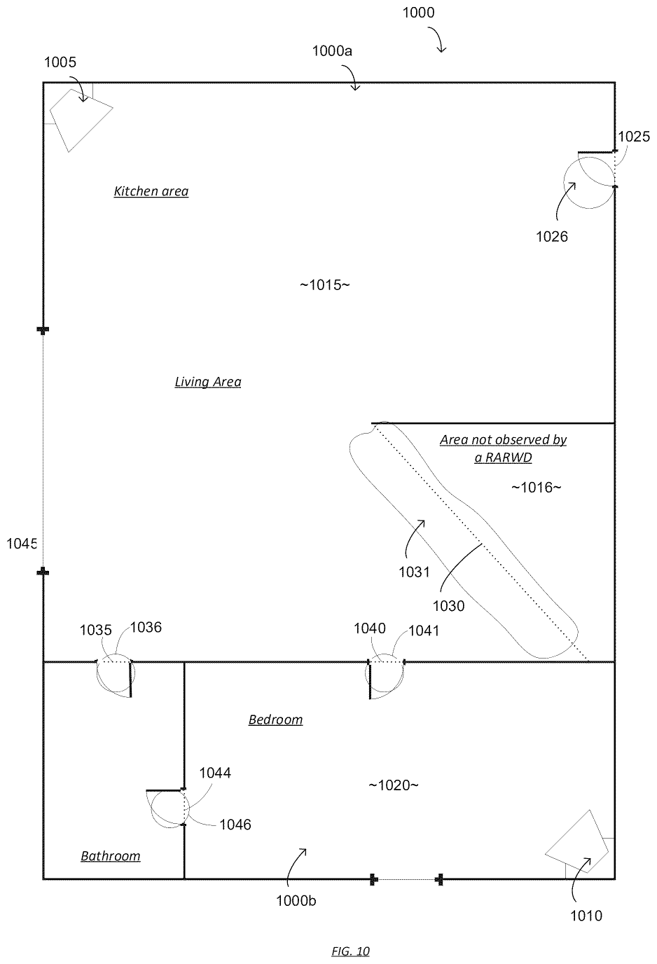

In the example of FIG. 11, a clustering algorithm may be applied to identify clusters or groups of RLFAs. Any suitable grouping technique or clustering algorithm could be used, such as K-means clustering, density-based clustering, distribution-based clustering, DBSCAN, or the like. In the example of FIG. 11, in order to determine if a person has entered the region via an anomalous entry location, it is determined if current locations of first appearance of a human for an entry into the monitored region captured in from the second set of RARWD measurements form a cluster with a predefined minimum number of RLFAs or a pre-identified cluster of RLFAs. For this purpose, the same clustering algorithm used to cluster the RLFAs may optionally be used. If such a cluster including the current location of first appearance and one or more RLFAs exists, then it may be determined that the current location of first appearance of a human for an entry into the region is non-anomalous and so it may be determined that the person did not enter the region via an anomalous entry location. This is indicated in the figure by referencing the current location of first interest by the acronym “LE” for legitimate entry. In contrast, in the example of FIG. 12, a current location of first appearance of a human for an entry into the monitored region is determined from the second set of RARWD measurements to not form a cluster with any of the RLFAs, or at least does not form a cluster with a threshold number of RLFAs. In this case, it is determined that the person entered the region via an anomalous entry location, and so the current location is denoted as IE, standing for illegitimate entry.

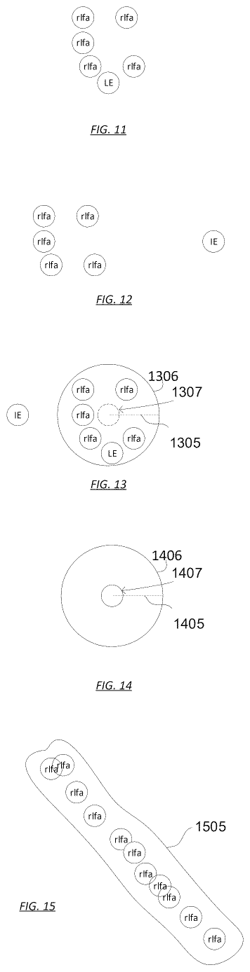

An alternative approach is shown in FIG. 13. In this case, in order to determine if a person has entered the region via an anomalous entry location, an acceptable entry detection region 1306 is expressly determined based on the RLFAs. In this example a central location of a cluster of RLFAs is determined, e.g. based on an average location 1307 of the RLFAs in the cluster. The acceptable entry detection region 1306 may have a circular horizontal area with a radius 1305 of a fixed predetermined size or calculated to include all of the RLFAs plus an additional margin. It is then determined whether the current location of first appearance of a human for an entry into the region from the second sets of RARWD measurements is within that acceptable entry detection region to thereby be a non-anomalous, legitimate entry (LE) or outside of that and any other acceptable entry detection region to thereby be an anomalous, illegitimate entry (IE).

If it is determined that the current location of first appearance of a human for an entry into the region is an anomalous, illegitimate entry (IE), the system controls an output to signal an occurrence of an anomalous entry event, which could result in, for example, raising of an alarm, providing a notification to a recipient list, initiating performance of a corroboration action by another device, updating an incident log or the like.

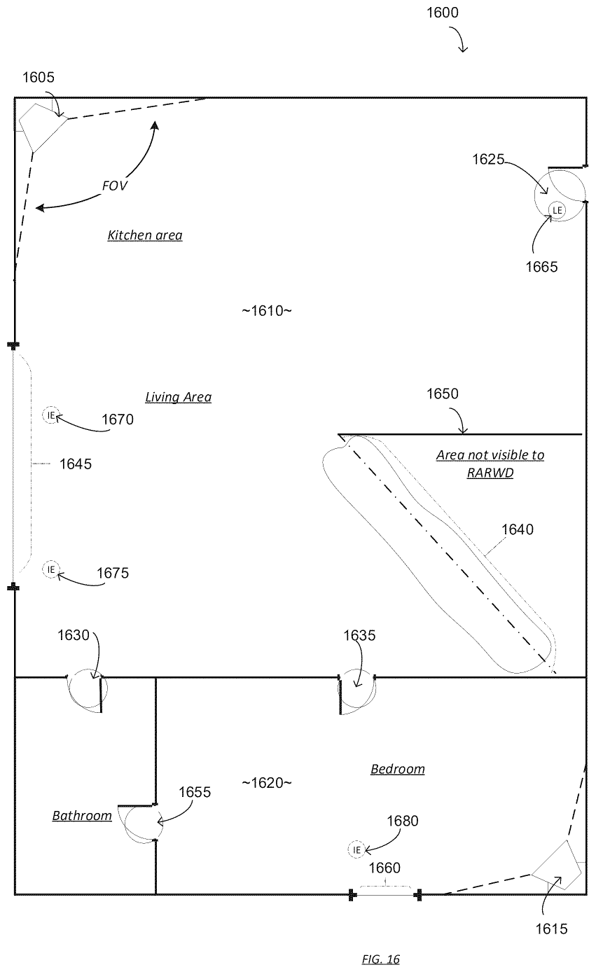

FIG. 14 shows an example in which, rather than defining an acceptable entry detection region about an average location or other reference location of a group or cluster of reference locations RLFA, an acceptable entry detection region 1406 is defined about each RLFA 1407, for example by defining circular horizontal area having a radius 1405 of a preset size.

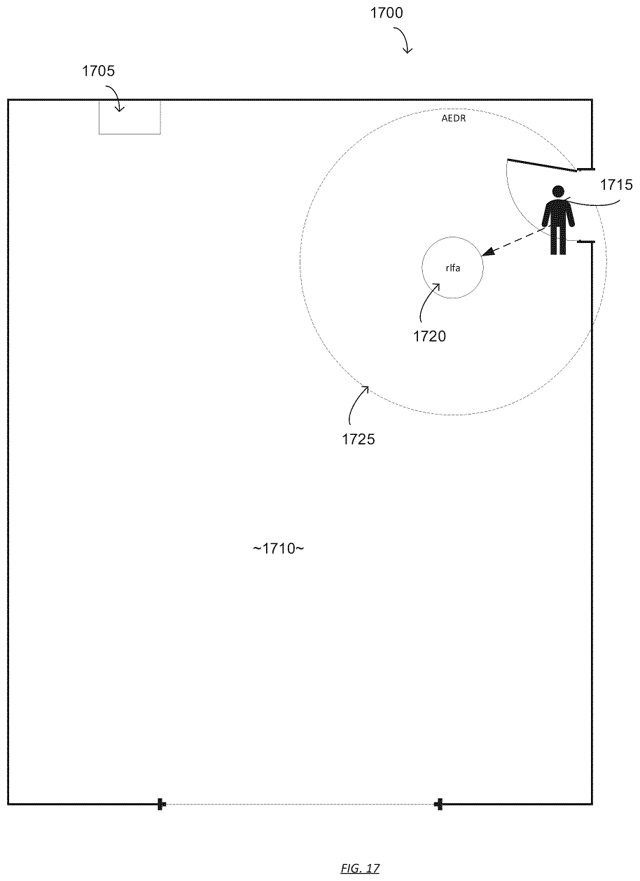

Adopting the approach of FIG. 14 to a case in which the first set of RARWD measurements represents a plurality of RLFAs that are close to one another, acceptable entry detection regions corresponding to the respective RLFAs may overlap resulting in a larger, combined acceptable entry detection location. Alternatively, the overlapping acceptable entry detection regions corresponding to the respective RLFAs may interact in other ways of union to form a combined acceptable entry detection region 1505, for example as illustrated in FIG. 15.

FIG. 16 shows another example of monitoring a region and a number of acceptable entry detection regions learned based on RLFAs (not shown in FIG. 16) with respect to the monitored region, for example using any one or more of the methods described in FIGS. 11 to 15. The region could be monitored using any of the systems 5, 205, 305 of any of FIG. 1, 2 or 3. FIG. 16 shows a plan view of a premises 1600 comprising a first RARWD 1605 for monitoring a first region 1610 and a second RARWD 1615 for monitoring a second region 1620.

The first region 1610 is associated with a plurality of learned acceptable entry detection regions 1625, 1630, 1635, 1640. Though the RARWD is not able to determine the structure of the premises, including where it's walls are, the location of valid entryways may at least be learned based on human behaviour. The plurality of acceptable entry detection regions 1625, 1630, 1635, 1640 include an acceptable entry detection region 1625 at an external doorway, acceptable entry detection regions 1630, 1635 at internal doorways and an acceptable entry detection region along a boundary 1640 of an area occluded from the RARWD 1605 by a projecting wall 1650 that is opaque to radiation from the RARWD. Each acceptable entry detection region 1625, 1630, 1635, 1640 is at an acceptable boundary crossing of the boundary of the region 1605.

In some examples, the first set of measurements from which the at least one acceptable entry detection region is determined are collected under comparable contextual conditions in which the second set of RARWD measurements are collected. For example, the first set of RARWD measurements can be associated with contextual data such as time, occupancy level, weather, calendar or diary data, user data, and/or the like, and can be compared to corresponding contextual data associated with the current second set of RARWD data, and the at least one acceptable boundary crossing that matches or is otherwise associated with the contextual data associated with the current second set of RARWD data can be used. For example, the comparable contextual conditions could comprise being during a same time of day. Thus, for example, what constitutes an acceptable boundary crossing at one time of day may, at a different time of day, not constitute an acceptable boundary crossing. As such, what constitutes an acceptable boundary crossing during the day may not be the same as what constitutes an acceptable boundary crossing at night or in the evening. In an example, entry through a rear door late at night might, when the rear door is not normally used, trigger an alarm at that time, but not at other times. As another example, the comparable contextual conditions could comprise having a comparable occupancy level or status prior to entry. Thus, in examples, what constitutes an acceptable entry detection region is dependent on whether a premises is determined to be occupied prior to entry or not. Although some examples of comparable contextual conditions have been provided above, the disclosure is not limited to these and other contextual conditions that could affect whether an acceptable entry detection region is applicable or not could be used.

In this example, all of the acceptable boundary crossings are in regular use, so an acceptable entry detection region 1625, 1630, 1635, 1640 is determined to exist at every acceptable boundary crossing. However, if an acceptable boundary crossing were not to be used, then no acceptable entry detection region would be learned to exist at that boundary crossing, and in fact, that boundary crossing would not be known to exist, let alone its approximate location. The boundary of the region 1600 also has an unacceptable boundary crossing 1645 spanning and due to an external window. However, no unacceptable entry detection region is identified with respect to the unacceptable boundary crossing 1645, and the existence of the unacceptable boundary crossing 1645 remains unknown.

The second region 1620 comprises a plurality of acceptable entry detection regions 1625, 1655. The acceptable entry detection regions 1625, 1655 span internal doorways, including one shared with the first region 1610. The boundary of the region 1620 also has an unacceptable access 1660 at and due to an external window. However, no unacceptable entry detection region is identified with respect to the unacceptable boundary crossing 1660, the existence of which is unknown.

Various examples of locations 1665, 1670, 1675, 1680 of first appearances of humans into the regions 1610, 1620 represented in RARWD measurements. The respective locations 1665, 1670, 1675, 1680 of first appearances are identified in respective second sets of RARWD measurements made by the RARWDs 1605, 1615 are shown. First appearances 1665, 1670, 1675, 1680 are all represented in RARWD measurements (in a respective second set of RARWD measurements) made by the first RARWD 1605 only, whereas first appearance 1680 is represented in RARWD measurements (in a second set of RARWD measurements) made by the second RARWD 1610 only. First appearance 1665 is within the acceptable boundary crossing 1625 spanning an external doorway. As such, this first appearance 1665 is determined to be within the acceptable entry detection region 1625 and so the requisite correlation with a RLFA and is deemed to be a non-anomalous entry for which no further action is required. In contrast, first appearances 1670, 1675 and 1680 are not within any of the acceptable entry detection regions 1625, 1630, 1635, 1640. As such, these first appearances 1670, 1675 and 1680 are deemed not to have the requisite correlation with the RLFAs and are deemed to be anomalous entry events.

These operations are different to the operation of a virtual fence. With a virtual fence, a simple determination is made whether a detected person is within or outside of an area defined by the virtual fence. In contrast, in examples described herein, it is permitted to detect people outside of the acceptable entry detection region, only that the “first appearance” of that person on entry into the monitored region must be within an acceptable entry detection region.

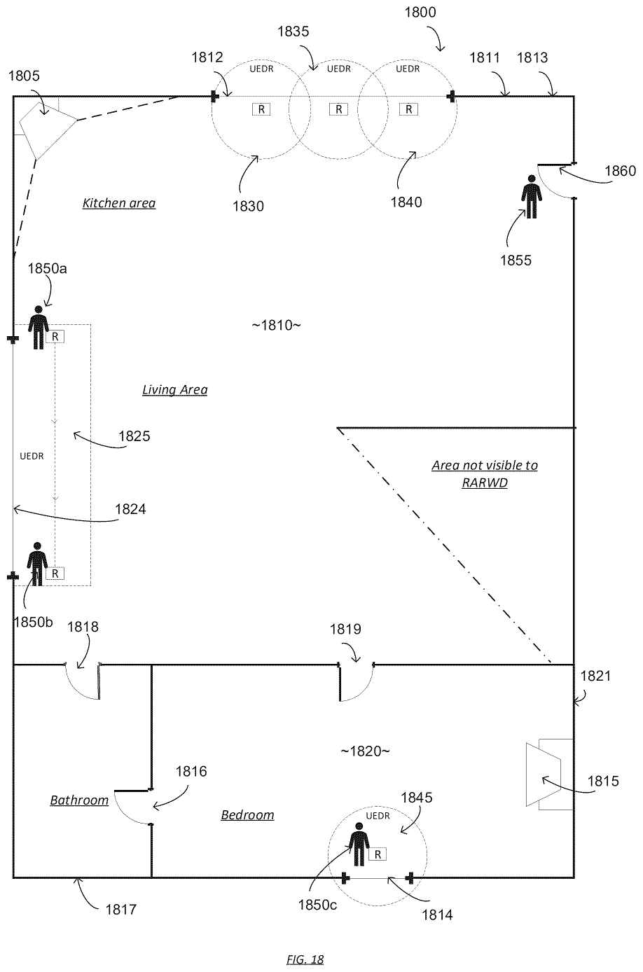

FIG. 17 shows an example of how a margin or radius with respect to a RLFA can be set when identifying an acceptable entry detection region. FIG. 17 shows a plan view of a premises 1700, that comprises a RARWD 1705 configured to monitor a region 1710 within the premises 1700. During a learning or training period, the RARWD 1705 detects a first entry of a person 1715 into the region 1710 through a doorway. Due to detection delays, e.g. due to a sample rate or frame rate of the RARWD 1705 or other measurement delays, the person 1715 may have progressed to location 1720 before being first detected by the RARWD 1705 after entry into the region 1710. In other words, the location 1720 may therefore be considered the location of first appearance of the person 1715, as derivable from the RARWD measurements. In determining the acceptable entry detection region 1725 around the location 1720 of first detection of the person after entry into the region 1710, a margin may be set based on a maximum measurement delay, e.g. based on a sample rate or frame rate of the RARWD 1705, so as to cover the doorway or other entry point associated with the location 1720 of first detection.

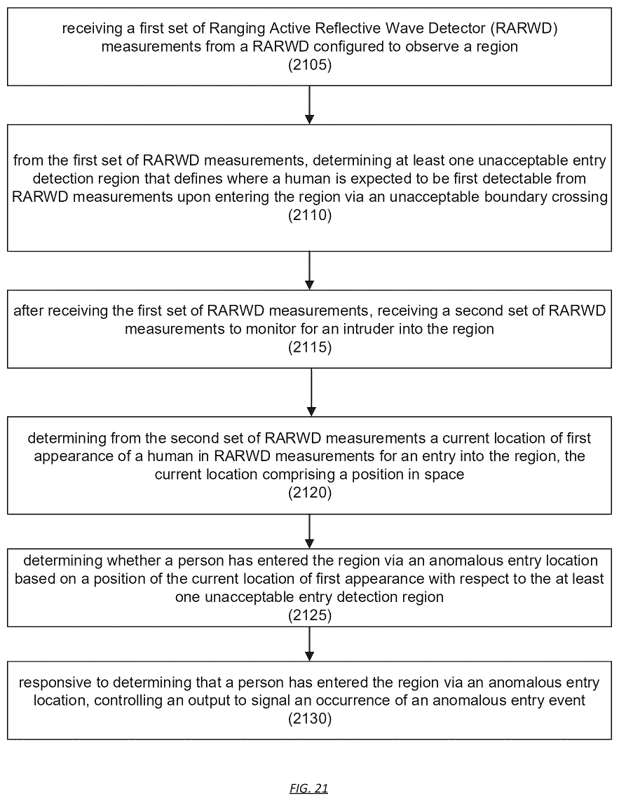

FIG. 20 is a flowchart illustrating a specific embodiment of the method of FIG. 5, and may involve the example of FIG. 16.

At 2005, a first set of Ranging Active Reflective Wave Detector (RARWD) measurements are received from a RARWD configured to observe a region. Any human present in the region is identifiable from the RARWD measurements and a position of any human in multiple spatial dimensions can also be derived from the RARWD measurements. For example, the first set of RARWD measurements could be collected using the device 400 or the sensing device 10a, 10b, 210a, 210b, 310c, 310d, 310e that comprises the RARWD in the systems 5, 205, 305 of any of FIG. 1, 2 or 3. In some examples, the first set of RARWD measurements are collected during a defined learning period, such as but not limited to a set-up period or a learning period selected by a user or installer or the like. The first set of RARWD measurements may be collected by a single RARWD or by multiple RARWDs and could be collected in a single session of over multiple different periods of time.

At 2010, at least one reference location of first appearance of a human's entry into a region that is represented in the first set of RARWD measurements is learned from the first set of RARWD measurements. The location is a point in space, e.g. a centre, weighted centre or other representative location within the detected human. The human may be identified by identifying a pre-set profile or other condition indicative of a human in the first set of RARWD measurements. The location of first appearance of a human in the first set of RARWD measurements for an entry into the region may be a location in an earliest measurement frame of the first set of RARWD measurements in which the human is detectable for a given instance of the human entering the region. Optionally from the reference locations of first appearance, one or more acceptable entry detection regions may be expressly determined, e.g. as in the examples of FIGS. 13 to 16.

At 2015, a second set of RARWD measurements are received for monitoring for intrusion into the region. The second set of RARWD measurements can be collected by the same RARWD as the first set, or a different RARWD.

At 2020, the second set of RARWD measurements are analysed to determine a current location of first appearance of a human in RARWD measurements for an entry into the region, the current location comprising a position in space. Determining a current location of first appearance from the second set of RARWD measurement could comprise a similar or same approach to that taken in step 2010 in relation to determining a reference location of first appearance from the first set of RARWD measurements.

At 2025, it is determined whether a person has entered the region via an anomalous entry location based on a position of the current location of first appearance with respect to the at least one reference location of first appearance. A person is determined to have entered the region via an anomalous entry location if the current location fails to have a requisite spatial proximity relationship with respect to the at least one reference location of first appearance, e.g. if it does not form a cluster with the at least one reference location of first appearance, or it is at least a threshold distance from any of the at least one reference locations of first appearance, or the like. This step is analogous to step 525 of FIG. 5, noting that one or more acceptable entry detection regions may be expressly or inferred from the reference locations of first appearance, and that the requisite spatial proximity relationship with respect to the at least one reference location of first appearance may comprise determining whether the current location of first appearance is within an acceptable entry detection location.

At 2030, if it is determined that a person has entered the region via an anomalous entry location, then an output is controlled to signal an occurrence of an anomalous entry event. Responsive to the anomalous entry event, then a further action can be taken, such as raising an alarm, notifying at least one pre-set contact, initiating a verification action to verify the present of an intruder, recording the anomalous entry event in a log, and/or the like.

FIG. 21 is a flowchart of a computer-implemented method of monitoring a region to detect an intruder entering a region having a boundary that includes one or more unacceptable boundary crossings that constitute some of the boundary, and where acceptable entry detection regions are defined for identifying when a person enters the region by crossing and unacceptable boundary crossing. The method of FIG. 21 can be implemented by the systems 5, 205, 305 of any of FIG. 1, 2 or 3 or the sensing device 400 of FIG. 4. The method of FIG. 21 involves the example of FIG. 18.

At 2105, a first set of Ranging Active Reflective Wave Detector (RARWD) measurements are received from a RARWD configured to observe a region.

At 2110, at least one unacceptable entry detections that defines where a human is expected to be first detectable from RARWD measurements upon entering the region via an unacceptable boundary crossing is determined from the first set of RARWD measurements, for example using the method described in relation to FIG. 18.

At 2115, a second set of RARWD measurements are received. The second set of RARWD measurements are RARWD measurements taken to monitor for an intruder into the region. In some examples, the second set of RARWD measurements are operational measurements taken when the system 5, 205, 305 is in an operational state in which it monitors for an intruder into the region. In examples, the second set of RARWD measurements are collected using the same RARWD sensing devices 10a, 10b, 210a, 210b, 310c, 310d, 310e, 400, used to collect the first set of RARWD measurements. However, different RARWD sensing devices could be used to collect the first and second set of RARWD measurements.

At 2120, the second set of RARWD measurements are analysed to determine a current location of first appearance of a human in RARWD measurements for an entry into the region, the current location comprising a position in space.

At 2125, it is determined whether a person has entered the region via an anomalous entry location based on a position of the current location of first appearance with respect to the at least one unacceptable entry detection region. A person is determined to have entered the region via an anomalous entry location if the current location is within an unacceptable entry detection region.

With reference again to FIG. 18, during operation based on second sets of RARWD measurements collected by RARWDs 1805, 1815, a person being first detected on entry into the region 1810 as being within any of the unacceptable entry detection regions 1830, 1835, 1840, 1845 would be treated as an anomalous entry event. However, a person being first detected out with the unacceptable entry detection regions 1830, 1835, 1840, 1845, such as at a location 1855 just inside an external door, would not be treated as an anomalous entry event. In this way, a person can enter through the external door (i.e. an acceptable boundary crossing) and subsequently move to any location in the premises 1800 without leaving the premises 1800, including into the unacceptable entry detection regions 1830, 1835, 1840, 1845 (since entrance into those regions will not then be detected entry into the monitored region 1810), without triggering an anomalous entry event detection.

At 2130, if it is determined that a person has entered the region via an anomalous entry location, then an output is controlled to signal an occurrence of an anomalous entry event. Responsive to the anomalous entry event, then a further action can be taken, such as raising an alarm, notifying at least one pre-set contact, initiating a verification action to verify the present of an intruder, recording the anomalous entry event in a log, and/or the like.

According to this approach, whereas the method of FIG. 5 learns explicit acceptable entry detection regions and uses them to identify anomalous entry events, the approach of FIG. 21 determines unacceptable entry detection regions and uses those to identify anomalous entry events. In the case of relying upon an acceptable entry detection region(s) to detect an anomalous entry event, having the acceptable entry detection region(s) cover all possible locations of first appearance of a human entering via the corresponding acceptable boundary crossing may reduce the number of false anomaly detections. By contrast, in the case of relying upon an unacceptable entry detection region(s) to detect an anomalous entry event, having the unacceptable entry detection(s) region cover all possible locations of first appearance of a human entering via the corresponding unacceptable boundary crossing may be more beneficial, since otherwise a person may enter the region via the unacceptable boundary crossing without detecting an anomalous entry event.

For each of the methods of FIGS. 20, 21 and 5, the RARWD may be set up to have a field of view that spans an unacceptable boundary crossing (e.g. where are a window is located) of a boundary of the monitored region. A method of configuring a RARWD for use in arrangements, such as those of examples of FIGS. 7, 9, 16, 18 and 19, that utilize unacceptable boundary crossings may comprise installing the RARWD at a location and orientation to have the unacceptable boundary crossing within, preferably entirely within, the field of view of the RARWD. The field of view may span all of the unacceptable boundary crossing and may also include a margin on all sides of the unacceptable boundary crossing. For clarity it will be appreciated that a door is used distinctly from a doorway, the latter being intended to be passed through. For the sake of clarity a transparent door, e.g. made of glass or plastic, is considered not to be a window.

The monitored region may be or comprise an interior space within a physical structure. The physical structure is configurable to create a closed space surrounded by one or more physical barriers not intended to be passed through by a human. The closed space is openable by at least one access point. The monitored region may also comprise one or more external regions to physical structure. The one or more physical barriers may comprise a wall, a window, and/or a door, for example.

In a first situation, the one or more external regions may be visible to the device only intermittently, e.g. when a normally closed access point is open (e.g. a door being transiently opened, assuming the door is opaque to waves emitted by the RARWD). In other words, when the door is opened, the RARWD, which is unaware of the shape of dimensions of the interior space, may be able to see through the doorway. Therefore, the boundary to the monitored region, and therefore the acceptable boundary crossing may be extended beyond the interior space, based on what RARAWD can see when the door is open.

For example, with reference to the embodiment of FIG. 5 in conjunction with FIG. 19, an acceptable entry detection region related to the door may be defined to comprise an area just outside the door (e.g. within 1 meter beyond the door), especially if the door opens outwardly.

In another example of the first situation, with reference to the embodiment of FIG. 20 in conjunction with FIG. 16, reference locations of first appearance may be identified just outside the door (e.g. within 1 meter beyond the door).

The first situation may optionally be avoided by setting up a virtual fence along a perimeter of normally closed region, at least where said door or other legitimate access point is located.

Additionally or alternatively, in a second situation, the one or more external regions may be visible to the device at any location at which one of the one or more physical barriers is at least partially transparent to waves emitted by the RARWD such that an object of interest (e.g. a person) beyond the barrier might be detectable by the RARWD (depending on how far the object is beyond the barrier and how transparent the barrier is).

The second situation may optionally be avoided by setting up a virtual fence along a perimeter of normally closed region, at least where said barrier that is at least partially transparent to waves emitted by the RARWD is located.

For either situation the boundary of the region being monitored may (if no virtual fence is set up) have one or more boundary crossings beyond rather than at the one or more physical barriers.

If an unacceptable boundary crossing is mapped inside the boundary, it May optionally be extended more distantly than the barrier. Optionally, with reference to FIG. 18 and FIG. 21, the device may automatically extend the unacceptable boundary crossing in a direction away from the RARWD, e.g. up to a maximum detection range of the RARWD (even though the maximum detection range through the window would be reduced by virtue of some opacity of the window to the waves transmitted by the RARWD.

The location of first appearance of a person may in some embodiments be where an actual person is detected. In other examples it may be where an event is detected as occurring where the event is caused by a person, e.g. an opening of a door. For example, a movement of a door may be detected from RARWD measurements, and this may be assumed to be a first appearance of a human. In other embodiments a determination of a first appearance of a person may require an identification, from RARWD measurements, of an object that appears to be human (optionally more specifically adult and/or adolescent humans, for example humans that are at least 10 years old), e.g. including an assessment based on estimated RCS of the object, etc.

More broadly references herein to a person may alternatively be to an object, or an object of interest, which may optionally include human and other selected objects. Such other selected objects could for example comprise a door or window (to identify the door or window moving in the monitored region), or a crowbar used to smash a window. Other objects may be considered not to be an object of interest, for example a non-human animal, such as or a bird, dog or and/a cat, in some embodiments. Similarly, a detected intrusion need not be a detection of a human intruder. It could be, for example, a detection of an object moving in the monitored region that may represent a person who may be an intruder and who has or is expected to enter the region.

Although various specific examples have been described above, the present disclosure is not limited by those specific examples, and implementations of features described in relation to one example in any of the other examples, or modifications of certain features are possible.

The output could be used as part of an identification of an intruder in the operation of an alarm system, as described above. The output being indicative of an anomalous entry event could initiate an alarm, a notification to a set recipient, initiation of a verification action by the RARWDs or a different device or by manual review, the recording of the anomalous entry event in a log or the like.

Furthermore, whilst specific examples having a given number and/or type of RARWDs, rooms, regions, acceptable boundary crossings and/or unacceptable boundary crossings are identified in specific examples, these could be varied, and other numbers and/or types of RARWDs, rooms, regions, acceptable boundary crossings and/or unacceptable boundary crossings could be provided.

The term “module,” as used herein generally represent software, firmware, hardware, or a combination thereof. In the case of a software implementation, the module represents program code that performs specified tasks when executed on a processor (e.g. CPU or CPUs). The program code can be stored in one or more computer readable memory devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

References to a processor made herein and any of the methods described herein could be implemented at least in part on a processor. However, the use of a processor herein should not be construed narrowly and could include a multi-core processor. Furthermore, the processor could be or include but are not limited to at least one of: one or more digital signal processors (DSPs), one or more field programmable gate arrays (FPGAs), one or more integrated FPGA/processor systems, one or more application specific integrated circuits (ASICS), an adaptive compute acceleration platform (ACAP), one or more system on chip (SoC) devices, one or more maths co-processors, one or more AI accelerators such as a tensor processing unit (TPU), one or more graphics processing units (GPUs) and the like.

At least part of the processes described herein could be implemented using software that is processed by suitable hardware to perform at least part of the process. This could be implemented by a computer. The term “computer” as used herein could be any electronic processing device or system, for example as described herein.

As such, the specific examples are provided herein to aid the understanding of the reader, and the scope of the present disclosure is not limited by the specific examples described herein.

As used herein, unless context demands otherwise, the expression “one or more of x and y” or “at least one of x and y”, should be interpreted to cover: (i) at least one x, (ii) at least one y, (iii) at least one x and at least one y. That is, there may be, but need not be, both element x and element y. The same applies to any equivalent expressions referring to more than two elements, e.g, the expression “at least one of x, y, and z”. The same interpretation should likewise be applied to the expressions “x, y, and/or z” and “at least x, y, and/or z”.

As used herein, except where the context requires otherwise, the terms “comprises”, “includes”, “has”, and grammatical variants of these terms, are not intended to be exhaustive. They are intended to allow for the possibility of further additives, components, integers or steps.

Consistent with the present disclosure, each of the following represent a respective exemplary embodiment of the present invention.

A first embodiment, which is a system for monitoring a region to detect an intrusion into a region having a boundary that includes one or more acceptable boundary crossings that constitute some of the boundary wherein the region is enterable via said one or more acceptable boundary crossings. The system comprises at least one processor configured to receive a first set of Ranging Active Reflective Wave Detector (RARWD) measurements from a RARWD configured to observe the region; from the first set of RARWD measurements, identify at least one acceptable entry detection region that defines where an object entering the region via an acceptable boundary crossing is expected to be first detectable upon entering the region; receive a second set of RARWD measurements to monitor for an intrusion into the region; determine from the second set of RARWD measurements a current location of first appearance of an object entering the region, the current location comprising a position in space; determine whether an object has entered the region via an anomalous entry location based on a position of the current location of first appearance with respect to the at least one acceptable entry detection region; and responsive to determining that an object has entered the region via an anomalous entry location, control an output to signal an occurrence of an anomalous entry event.

A second embodiment, which is the system of the first embodiment, wherein the current location of first appearance of an object entering the region comprises a current location of first appearance of a human entering the region.

A third embodiment, which is the system of any preceding embodiment, wherein the determining of the at least one acceptable entry detection region comprises identifying at least one reference location of first appearance of an object entering the region, each of the at least one reference locations comprising a position in space; wherein the at least one acceptable entry detection region comprises the at least one reference location of first appearance.

A fourth embodiment, which is the system of the third embodiment, wherein the identifying of the at least one reference location of first appearance of an object comprises identifying all locations of first appearances of an object during a training period.

A fifth embodiment, which is the system of the third or fourth embodiment, wherein the identifying the at least one reference location of first appearance of an object comprises detecting a new object in the region based on the first set of RARWD measurements, which comprises one or both of: the RARWD being configured to operate before the new object enters the region, and detecting the new object in the region by monitoring the region until the new object is detected; and/or the RARWD being configured to be triggered to monitoring the region for the new object in response to a triggering event representing a detected motion or a detected presence of an object in and/or adjacent the region.

A sixth embodiment, which is the system of any preceding embodiment, configured to identify the at least one acceptable entry detection region based on one or more entries to the region that change an occupancy of the region being monitored or an interior of a premises from unoccupied to occupied; and/or when identifying the at least one acceptable entry detection region, exclude entries to the interior whilst the region being monitored or an interior of a premises is already occupied or for which an immediately prior occupancy status of the monitored region is unknown.

A seventh embodiment, which is the system of the sixth embodiment when dependent on the second embodiment, wherein the premises comprises a building, part of the boundary of the region is provided by a wall of the building, and at least one of the acceptable boundary crossings is provided by a doorway.

An eighth embodiment, which is the system of any preceding embodiment, wherein the boundary also includes at least one unacceptable boundary crossing, wherein the region is also enterable by an object via said at least one unacceptable boundary crossing; the system is configured to identify at least one unacceptable entry detection region that defines where an object is expected to be first detectable from RARWD measurements upon entering the region via the at least one unacceptable boundary crossing; and the determining of whether an object has entered the region via an anomalous entry location is based in part on a position of the current location of first appearance with respect to the at least one unacceptable entry detection region.

A ninth embodiment, which is the system of any preceding embodiment, wherein the identifying of the at least one acceptable entry detection region and/or the at least one unacceptable entry detection region comprises identifying an object based on known measurement parameters associated with the object.

A tenth embodiment, which is the system of the ninth embodiment, configured to identify that at least one acceptable entry detection region and/or the at least one unacceptable entry detection region by one or both of: tracking the object to define a path traversed by the object over a period of time, and identifying the at least one acceptable entry detection region and/or the at least one unacceptable entry detection region based on the path traversed; and/or identifying a location of the object and identifying the at least one acceptable entry detection region and/or the at least one unacceptable entry detection region as comprising a region surrounding and/or adjacent the object.

An eleventh embodiment, which is the system of any preceding embodiment, wherein each location of first appearance of an object entering the region comprises a respective location based on an earliest set of measurement frames in which the object is detectable for a respective instance of the object entering the region.

A twelfth embodiment, which is the system of any preceding embodiment, configured such that: after an object is first detected in the region from the second RARWD measurements, the system is configured to receive further RARWD measurements and, from the further RARWD measurements, track a position of the object; and conditional upon having determined that the object has not entered the region via an anomalous entry location, the object can, while being tracked, travel to the anomalous entry location without causing the output to signal an occurrence of an anomalous entry event.

A thirteenth embodiment, which is the system of the third embodiment or any dependent embodiment thereon, configured such that the determining of whether an object has entered the region via an anomalous entry location based on a position of the current location with respect to the at least one reference location of first appearance comprises determining whether the current location fails to have a requisite spatial proximity relationship with respect to the at least one reference location of first appearance.

A fourteenth embodiment, which is the system of the third embodiment or any dependent embodiment thereon, wherein the at least one reference location of first appearance of an object comprises a plurality of reference locations of first appearance of an object for respective entries of a plurality of entries into the region.

A fifteenth embodiment, which is the system of the thirteenth embodiment or any dependent embodiment thereon, wherein having the requisite proximity relationship comprises: the current location of first appearance being within an acceptable entry detection region, each acceptable entry detection region comprising at least a predefined number of the reference locations of first appearance; or the current location of first appearance being part of a spatial cluster of locations, the spatial cluster including at least a predefined number of the reference locations of first appearances.

A sixteenth embodiment, which is the system of the fifteenth embodiment, configured to calculate the predefined number, wherein the predefined number is dependent on a total number of the at least one reference locations; and/or the predefined number is calculated to represent a minimum required likelihood for an object's first appearance in the region to be in a given detection region.

A seventeenth embodiment, which is the system of any preceding embodiment, wherein the region monitored by the RARWD is one of: an entire observable region from which the RARWD is configured to detect reflected waves, the entire observable region comprising an interior space within a physical structure, the physical structure being is closable by having one or more physical barriers not intended to be passed through by a human; or a region within a virtual fence, the virtual fence defining a sub-region of an entire region from which the RARWD is configured to detect reflected waves.

An eighteenth embodiment, which is the system of the seventeenth embodiment, wherein the region monitored by the RARWD comprises an entire observable region from which the RARWD is configured to detect reflected waves, the entire observable region being a union of: an interior space within a physical structure, the physical structure being closable by having one or more physical barriers not intended to be passed through by a human; and one or more external regions to the physical structure that are at least sometimes visible to the RARWD.

A nineteenth embodiment, which is the system of any preceding embodiment, wherein the system is, or comprises, or is configured to operate an alarm system.

A twentieth embodiment, which is the system of any preceding embodiment, wherein the system is configured to determine whether the object is human based on the second set of RARWD measurements, the determining of whether the object is human comprising identifying that at least one property and/or at least one profile of properties of the second set of RARWD measurements is indicative of a human.

A twenty-first embodiment, which is the system of any preceding embodiment, configured to one or both of: collect the first set of measurements and/or learn at least one reference location of first appearance under comparable contextual conditions to one or both of: collecting the second set of measurements; and/or determining from the second set of RARWD measurements the current location of first appearance.

A twenty-second embodiment, which is the system of the twenty-first embodiment, wherein the comparable contextual conditions comprise at least one of: being during a same time of day or part of the day; and/or having a comparable occupancy level or status prior to entry.

A twenty-third embodiment, which is the system of any preceding embodiment, wherein the identifying the at least one acceptable entry detection region comprises learning the at least one acceptable entry detection region from the first set of RARWD measurements.

A twenty-fourth embodiment, which is a computer-implemented method of monitoring a region to detect an intrusion into a region having a boundary that includes one or more acceptable boundary crossings that constitute some of the boundary wherein the region is enterable via said one or more acceptable boundary crossings. The method comprises receiving a first set of Ranging Active Reflective Wave Detector (RARWD) measurements made by a RARWD configured to observe the region; from the first set of RARWD measurements, identifying at least one acceptable entry detection region that defines where an object entering the region via an acceptable boundary crossing is expected to be first detectable upon entering the region; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one acceptable entry detection region; and responsive to determining that an object has entered the region via an anomalous entry location, controlling an output to signal an occurrence of an anomalous entry event.

A twenty-fifth embodiment, which is a tangible, non-transient computer readable carrier medium carrying a computer program product configured such that when executed by a system comprising at least one processor, causes the system to monitor a region to detect an intrusion into a region having a boundary that includes one or more acceptable boundary crossings that constitute some of the boundary, wherein the region is enterable via said one or more acceptable boundary crossings. The monitoring comprises receiving a first set of Ranging Active Reflective Wave Detector (RARWD) measurements from a RARWD configured to observe the region; from the first set of RARWD measurements, identifying at least one acceptable entry detection region that defines where an object entering the region via an acceptable boundary crossing is expected to be first detectable upon entering the region; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one acceptable entry detection region; and responsive to determining that an object has entered the region via an anomalous entry location, controlling an output to signal an occurrence of an anomalous entry event.

A twenty-sixth embodiment, which is a system for monitoring a region to detect an intrusion. The system comprises at least one processor and is configured to receive a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; receive a second set of RARWD measurements to monitor for an intrusion into the region; determine from the second set of RARWD measurements a current location of first appearance of an object entering the region, the current location comprising a position in space; determine whether an object has entered the region via an anomalous entry location based on a position of the current location of first appearance with respect to the at least one reference location of first appearance; and responsive to determining that an object has entered the region via an anomalous entry location, control an output to signal an occurrence of an anomalous entry event.

A twenty-seventh embodiment, which is the system of the twenty-sixth embodiment, configured to define, or receive a definition of, at least one acceptable entry detection region, each acceptable entry detection region comprising the at least one reference location of first appearance of an object; and the system is configured to determine that an object has entered the region via an anomalous entry location if the current location of first appearance is within the acceptable entry detection region.

A twenty-eighth embodiment, which is a computer-implemented method of monitoring a region to detect an intrusion. The method comprises receiving a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one reference location of first appearance; and responsive to determining that an object has entered the region via an anomalous entry location, controlling an output to signal an occurrence of an anomalous entry event.

A twenty-ninth embodiment, which is a tangible, non-transient computer readable carrier medium carrying a computer program product configured such that when executed by a system comprising at least one processor, causes the system to monitor a region to detect an intrusion. The monitoring comprises receiving a first set of Ranging Active Reflective Wave Detector (RARWD) measurements for a region observed by an RARWD; from the first set of RARWD measurements, identifying at least one reference location of first appearance of an object entering the region, each of the at least one reference locations comprising a position in space; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one reference location of first appearance; and responsive to determining that an object has entered the region via an anomalous entry location, controlling an output to signal an occurrence of an anomalous entry event.

A thirtieth embodiment, which is a computer-implemented method of monitoring a region to detect an intrusion into a region having a boundary that includes one or more unacceptable boundary crossings that constitute some of the boundary wherein the region is enterable via said one or more unacceptable boundary crossings. The method comprises receiving a first set of Ranging Active Reflective Wave Detector (RARWD) measurements from an RARWD configured to observe the region; from the first set of RARWD measurements, identifying at least one unacceptable entry detection region that defines where an object entering the region via an unacceptable boundary crossing is expected to be first detectable upon entering the region; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one unacceptable entry detection region; and responsive to determining that an object has entered the region via an anomalous entry location, controlling an output to signal an occurrence of an anomalous entry event.

A thirty-first embodiment, which is the method of the thirtieth embodiment, wherein the boundary also includes at least one acceptable boundary crossing, wherein the region is also enterable by a human via said at least one acceptable boundary crossing, and a human can enter the region via the at least one acceptable boundary crossing to be first detected at a location outside said at least one unacceptable entry detection region.

A thirty-second embodiment, which is the method of the thirtieth or thirty-first embodiment, wherein determining whether an object has entered the region via an anomalous entry location comprises determining whether the current location is within any of the at least one unacceptable entry detection regions, wherein in response to the determining that the current location is within any of the one unacceptable entry detection regions the method comprises determining that an object has entered the region via an anomalous entry location.

A thirty-third embodiment, which is a system for monitoring a region to detect an intrusion into a region having a boundary that includes one or more unacceptable boundary crossings that constitute some of the boundary, wherein the region is enterable via said one or more unacceptable boundary crossings. The system comprises at least one processor and is configured to receive a first set of Ranging Active Reflective Wave Detector (RARWD) measurements from an RARWD configured to observe the region; from the first set of RARWD measurements, determine at least one unacceptable entry detection region that defines where an object entering the region via an unacceptable boundary crossing is expected to be first detectable upon entering the region; receive a second set of RARWD measurements to monitor for an intrusion into the region; determine from the second set of RARWD measurements a current location of first appearance of an object entering the region, the current location comprising a position in space; determine whether an object has entered the region via an anomalous entry location based on a position of the current location of first appearance with respect to the at least one unacceptable entry detection region; and responsive to determining that an object has entered the region via an anomalous entry location, control an output to signal an occurrence of an anomalous entry event.

A thirty-fourth embodiment, which is a tangible, non-transient computer readable carrier medium carrying a computer program product, the computer program product configured such that, when executed by a system comprising at least one processor, causes the system to monitor a region to detect an intrusion into a region having a boundary that includes one or more unacceptable boundary crossings that constitute some of the boundary, wherein the region is enterable via said one or more unacceptable boundary crossings. The monitoring comprises receiving a first set of Ranging Active Reflective Wave Detector (RARWD) measurements from an RARWD configured to observe the region; from the first set of RARWD measurements, identifying at least one unacceptable entry detection region that defines where an object entering the region via an unacceptable boundary crossing is expected to be first detectable upon entering the region; receiving a second set of RARWD measurements to monitor for an intrusion into the region; determining from the second set of RARWD measurements a current location of first appearance of an object entering the region, the current location comprising a position in space; determining whether an object has entered the region via an anomalous entry location based on a position of the current location of first appearance with respect to the at least one unacceptable entry detection region; and responsive to determining that an object has entered the region via an anomalous entry location, controlling an output to signal an occurrence of an anomalous entry event.

A thirty-fifth embodiment, which is a method of configuring the system of the first to twenty-third embodiments or the thirty-third embodiment, the system comprising the RARWD that is for making one or both of the first set of RARWD measurements and/or the second set of RARWD measurements, wherein the RARWD has a field of view and the boundary of the region includes an unacceptable boundary crossing, and the method comprises installing the RARWD at a location and orientation to have the unacceptable boundary crossing within the field of view.

A thirty-sixth embodiment, which is the method of the thirty-fifth embodiment, wherein the installing of the RARWD comprises installing the RARWD at a location and orientation to have the unacceptable boundary crossing entirely within the field of view.

A thirty-seventh embodiment, which is the method of the thirty-fifth or thirty-sixth embodiment, wherein the installing of the RARWD comprises installing the RARWD at a location and orientation such that the field of view also spans one or more of the acceptable boundary crossings.

In these clauses, references to “the region” are distinct to references to any subcategories categories of regions. Thus, references to “the region” are not references to the acceptable entry detection or unacceptable entry detection region.

1. A system for monitoring a region to detect an intrusion into the region, the region having a boundary that includes one or more acceptable boundary crossings that constitute some of the boundary wherein the region is enterable via said one or more acceptable boundary crossings, the system comprising at least one processor that, at least when the processor is operating, is configured to:
receive a first set of Ranging Active Reflective Wave Detector (RARWD) measurements from a RARWD configured to observe the region;
from the first set of RARWD measurements, identify at least one acceptable entry detection region that defines where an object entering the region via an acceptable boundary crossing is expected to be first detectable upon entering the region;
receive a second set of RARWD measurements to monitor for an intrusion into the region;
determine from the second set of RARWD measurements a current location of first appearance of an object entering the region, the current location comprising a position in space;
determine whether an object has entered the region via an anomalous entry location based on a position of the current location of first appearance with respect to the at least one acceptable entry detection region; and
responsive to determining that an object has entered the region via an anomalous entry location, control an output to signal an occurrence of an anomalous entry event.

2. The system of claim 1, wherein the identifying of the at least one acceptable entry detection region comprises identifying at least one reference location of first appearance of an object entering the region, each of the at least one reference locations comprising a position in space; wherein the at least one acceptable entry detection region comprises the at least one reference location of first appearance.

3. The system of claim 2, configured such that the determining of whether an object has entered the region via an anomalous entry location based on a position of the current location with respect to the at least one reference location of first appearance comprises determining whether the current location fails to have a requisite spatial proximity relationship with respect to the at least one reference location of first appearance.

4. The system of claim 2, wherein the identifying the at least one reference location of first appearance of an object comprises detecting a new object in the region based on the first set of RARWD measurements, which comprises one or both of:
the RARWD being configured to operate before the new object enters the region, and detecting the new object in the region by monitoring the region until the new object is detected; and
the RARWD being configured to be triggered to monitoring the region for the new object in response to a triggering event representing a detected motion or a detected presence of an object in and/or adjacent the region.

5. The system of claim 1, configured to:
identify the at least one acceptable entry detection region based on one or more entries to the region that change an occupancy of the region being monitored or an interior of a premises from unoccupied to occupied; and/or
when identifying the at least one acceptable entry detection region, exclude entries:
to an interior of a premises whilst the region being monitored or the interior of the premises is already occupied; and/or
for which an occupancy status of the monitored region immediately prior to the entry is unknown.

6. The system of claim 1, configured such that:
after an object is first detected in the region from the second RARWD measurements, the system is configured to receive further RARWD measurements and, from the further RARWD measurements, track a position of the object; and
conditional upon having determined that the object has not entered the region via an anomalous entry location, the object can, while being tracked, travel to the anomalous entry location without causing the output to signal an occurrence of an anomalous entry event.

7. The system of claim 1, configured to one or both of: collect the first set of measurements and/or learn at least one reference location of first appearance under comparable contextual conditions to one or both of:
collecting the second set of measurements; and/or
determining from the second set of RARWD measurements the current location of first appearance.

8. A computer-implemented method of monitoring a region to detect an intrusion into a region having a boundary that includes one or more acceptable boundary crossings that constitute some of the boundary wherein the region is enterable via said one or more acceptable boundary crossings, the method comprising:
receiving a first set of Ranging Active Reflective Wave Detector (RARWD) measurements made by a RARWD configured to observe the region;
from the first set of RARWD measurements, identifying at least one acceptable entry detection region that defines where an object entering the region via an acceptable boundary crossing is expected to be first detectable upon entering the region;
receiving a second set of RARWD measurements to monitor for an intrusion into the region;
determining from the second set of RARWD measurements a current location of first appearance of an object entering the region, the current location comprising a position in space;
determining whether an object has entered the region via an anomalous entry location based on a position of the current location of first appearance with respect to the at least one acceptable entry detection region; and
responsive to determining that an object has entered the region via an anomalous entry location, controlling an output to signal an occurrence of an anomalous entry event.

9. A tangible non-transient computer readable carrier medium carrying instructions that when executed by at least one processor cause the at least one processor to monitor a region to detect an intrusion into a region having a boundary that includes one or more acceptable boundary crossings that constitute some of the boundary, wherein the region is enterable via said one or more acceptable boundary crossings, the monitoring comprising:
receiving a first set of Ranging Active Reflective Wave Detector (RARWD) measurements from a RARWD configured to observe the region;
from the first set of RARWD measurements, identifying at least one acceptable entry detection region that defines where an object entering the region via an acceptable boundary crossing is expected to be first detectable upon entering the region;
receiving a second set of RARWD measurements to monitor for an intrusion into the region;
determining from the second set of RARWD measurements a current location of first appearance of an object entering the region, the current location comprising a position in space;
determining whether an object has entered the region via an anomalous entry location based on a position of the current location of first appearance with respect to the at least one acceptable entry detection region; and
responsive to determining that an object has entered the region via an anomalous entry location, controlling an output to signal an occurrence of an anomalous entry event.

10. The non-transient computer readable carrier medium of claim 9, wherein the identifying of the at least one acceptable entry detection region comprises identifying at least one reference location of first appearance of an object entering the region, each of the at least one reference locations comprising a position in space; wherein the at least one acceptable entry detection region comprises the at least one reference location of first appearance, wherein the identifying of the at least one reference location of first appearance of an object comprises identifying all locations of first appearances of an object during a training period.

11. The non-transient computer readable carrier medium of claim 10, wherein the determining of whether an object has entered the region via an anomalous entry location based on a position of the current location with respect to the at least one reference location of first appearance comprises determining whether the current location fails to have a requisite spatial proximity relationship with respect to the at least one reference location of first appearance.

12. The non-transient computer readable carrier medium of claim 10, wherein the identifying the at least one reference location of first appearance of an object comprises detecting a new object in the region based on the first set of RARWD measurements, which comprises one or both of:
the RARWD being configured to operate before the new object enters the region, and detecting the new object in the region by monitoring the region until the new object is detected; and
the RARWD being configured to be triggered to monitoring the region for the new object in response to a triggering event representing a detected motion or a detected presence of an object in and/or adjacent the region.

13. The non-transient computer readable carrier medium of claim 9, wherein the at least one processor is further configured to:
identify the at least one acceptable entry detection region based on one or more entries to the region that change an occupancy of the region being monitored or an interior of a premises from unoccupied to occupied; and/or
when identifying the at least one acceptable entry detection region, exclude entries:
to an interior of a premises whilst the region being monitored or the interior of the premises is already occupied; and/or
for which an occupancy status of the monitored region immediately prior to the entry is unknown.

14. The non-transient computer readable carrier medium of claim 9, wherein the identifying of the at least one acceptable entry detection region comprises identifying an object based on known measurement parameters associated with the object, wherein the system is configured to identify the at least one acceptable entry detection region by one or both of:
tracking the object to define a path traversed by the object over a period of time, and identifying the at least one acceptable entry detection region and/or the at least one unacceptable entry detection region based on the path traversed; and/or
identifying a location of the object and identifying the at least one acceptable entry detection region as comprising a region surrounding and/or adjacent the object.

15. The non-transient computer readable carrier medium of claim 9, wherein the at least one processor is configured to:
after an object is first detected in the region from the second RARWD measurements, the system is configured to receive further RARWD measurements and, from the further RARWD measurements, track a position of the object;
wherein conditional upon having identified that the object has not entered the region via an anomalous entry location, the object can, while being tracked, travel to the anomalous entry location without causing the output to signal an occurrence of an anomalous entry event.

16. The non-transient computer readable carrier medium of claim 10, wherein the at least one reference location of first appearance of an object comprises a plurality of reference locations of first appearance of an object for respective entries of a plurality of entries into the region, wherein having the requisite proximity relationship comprises:
the current location of first appearance being within an acceptable entry detection region, each acceptable entry detection region comprising at least a predefined number of the reference locations of first appearance; or
the current location of first appearance being part of a spatial cluster of locations, the spatial cluster including at least a predefined number of the reference locations of first appearances.

17. The non-transient computer readable carrier medium of claim 9, wherein the region monitored by the RARWD is one of:
an entire observable region from which the RARWD is configured to detect reflected waves, the entire observable region comprising an interior space within a physical structure, the physical structure being closable by having one or more physical barriers not intended to be passed through by a human; or
a region within a virtual fence, the virtual fence defining a sub-region of an entire region from which the RARWD is configured to detect reflected waves.

18. The non-transient computer readable carrier medium of claim 9, wherein the at least one processor is further configured to one or both of: collect the first set of measurements and/or learn at least one reference location of first appearance under comparable contextual conditions to one or both of:
collecting the second set of measurements; and/or
determining from the second set of RARWD measurements the current location of first appearance, wherein the comparable contextual conditions comprise at least one of:
being during a same time of day or part of the day; and/or
having a comparable occupancy level or status prior to entry.

19. A system for monitoring a region to detect an intrusion, the system comprising at least one processor and configured to:
receive a first set of Ranging Active Reflective Wave Detector (RARWD) measurements for a region observed by an RARWD;
from the first set of RARWD measurements, identifying at least one reference location of first appearance of an object entering the region, each of the at least one reference locations comprising a position in space;
receive a second set of RARWD measurements to monitor for an intrusion into the region;
determine from the second set of RARWD measurements a current location of first appearance of an object entering the region, the current location comprising a position in space;
determine whether an object has entered the region via an anomalous entry location based on a position of the current location of first appearance with respect to the at least one reference location of first appearance; and
responsive to determining that an object has entered the region via an anomalous entry location, control an output to signal an occurrence of an anomalous entry event.

20. A tangible non-transient computer readable carrier medium carrying instructions that when executed by at least one processor cause the at least one processor to monitor a region to detect an intrusion, the monitoring comprising:
receiving a first set of Ranging Active Reflective Wave Detector (RARWD) measurements for a region observed by an RARWD;
from the first set of RARWD measurements, identifying at least one reference location of first appearance of an object entering the region, each of the at least one reference locations comprising a position in space;
receiving a second set of RARWD measurements to monitor for an intrusion into the region;
determining from the second set of RARWD measurements a current location of first appearance of an object entering the region, the current location comprising a position in space;
determining whether an object has entered the region via an anomalous entry location based on a position of the current location of first appearance with respect to the at least one reference location of first appearance; and
responsive to determining that an object has entered the region via an anomalous entry location, controlling an output to signal an occurrence of an anomalous entry event.
